(19) United States
(12) Patent Application Publication
(10) Pub. No.: US 2026/0080295 A1
(43) Pub. Date: Mar. 19, 2026

(54) METHODS AND SYSTEMS FOR ERROR CORRECTION IN NEUTRAL ATOM QUANTUM COMPUTERS

(71) Applicant: ATOM COMPUTING INC., Berkeley, CA (US)

(72) Inventor: Daniel CROW, Oakland, CA (US)

(21) Appl. No.: 19/093,045

(22) Filed: Mar. 27, 2025

Related U.S. Application Data
(63) Continuation of application No. PCT/US2024/018180, filed on Mar. 1, 2024.
(60) Provisional application No. 63/488,407, filed on Mar. 3, 2023.

(51) Int. Cl. G06N 10/70; G06N 10/20

(52) U.S. Cl. CPC G06N 10/70; G06N 10/20

(57) ABSTRACT

A method for error corrected quantum computation may include identifying that a qubit has been lost; replacing the qubit; reimplementing the qubit into the circuit; and flagging measurements taken while the qubit was missing as untrustworthy.

### CROSS-REFERENCE

This application is the by-pass continuation of International Application No. PCT/US2024/018180, filed Mar. 1, 2024, which claims the benefit of U.S. Provisional Application No. 63/488,407, filed Mar. 3, 2023, each of which are incorporated herein by reference in their entirety.

### STATEMENT AS TO FEDERALLY SPONSORED RESEARCH

This invention was made with the support of the United States Government under Grant Numbers 2040527 (Phase I) and 2134345 (Phase II) awarded by the National Science Foundation through the Convergence Accelerator Research Program. The United States Government has certain rights in this invention.

### BACKGROUND

Quantum error correction may be used in quantum computing to account for errors from decoherence and noise. Quantum error correction may be important to developing larger scale quantum computers. Errors may be generated by errors in preparing a gate, in executing a gate, in measuring a gate, etc.

### SUMMARY

Systems and method disclosed herein may improve methods and systems for correction of errors in quantum computers by better accounting for errors due to atom loss.

In an aspect, the present disclosure provides a method for error corrected quantum computation. The method may comprise: (a) identifying that a qubit has been lost; (b) replacing the qubit; (c) reimplementing the qubit into the circuit; and (d) flagging measurements taken while the qubit was missing as untrustworthy.

In some embodiments, identifying in (a) comprises using a plurality of swap gates. In some embodiments, a swap gate within the plurality of swap gates is implemented as a plurality of CNOT gates. In some embodiments, the method further comprises measuring alternating atoms in a lattice; performing the plurality of swap gates to transfer data stored on data qubits to ancilla qubits; and measuring the swapped data qubits to identify one or more lost atoms. In some embodiments, identifying in (a) comprises using a modified knock-knock protocol, wherein the modified knock-knock protocol comprises: providing a first atom to be probed using a second atom, wherein the second atom is an ancilla qubit, preparing the second atom in a |+>state; applying a modified control-Z gate between the first atom and the second atom based on a Rydberg interaction; and rotating the second qubit back to a computational basis and performing a measurement.

In some embodiments, reimplementing in (c) comprises (i) use of a decoder algorithm, wherein the decoder algorithm takes in a graph and determines a set of edges. In some embodiments, prior to (i) the method comprises updating a matching graph passed to the decoder algorithm based on a predicted probability distribution of a lost qubit replaced in (b). In some embodiments, reimplementing in (c) comprises use of a minimum-weight perfect matching decoder algorithm. In some embodiments, the method further comprises updating a matching graph passed to the minimum-weight perfect matching decoder algorithm based on a predicted probability distribution of a lost qubit replaced in (b). In some embodiments, the method further comprises: if an ancilla qubit is lost, updating the matching graph so that a node involving the ancilla qubit is connected by edges corresponding to the predicted probability distribution, and if a data qubit is lost, updating the matching graph by assigning the predicted probability distribution to each node involving the data qubit. In some embodiments, each node involving the ancilla qubit is updated.

In some embodiments, (a)-(d) are performed during a quantum computation circuit. In some embodiments, (a)-(d) are performed without measurement of each or a plurality of data qubits. In some embodiments, (a)-(d) are performed substantially without loss of coherence of each or a plurality of data qubits. In some embodiments, (d) comprises flagging measurements taken during a window of time that includes a time when the qubit was missing as untrustworthy.

In some embodiments, the qubit is a trapped atom qubit. In some embodiments, the trapped atom qubit is a neutral atom qubit. In some embodiments, the neutral atom qubit is a Group II element or a Group II-like element. In some embodiments, the Group II element or a Group II-like element comprises Ytterbium, Rubidium, Cesium, or Strontium. In some embodiments, the qubit comprises qubit states comprising nuclear spin states on the ¹S₀ manifold.

In some embodiments, (a) comprises an operation in which a two-qubit interaction between a qubit and a lost qubit has an effect of a Pauli operation or an identity operation on the qubit. In some embodiments, the two-qubit interaction comprises an excitation of a nuclear spin state of a neutral atom to a Rydberg state of the neutral atom.

In some embodiments, reimplementing in (c) comprises (i) implementing a decoder, wherein the decoder is configured to receive a matching graph and to determine a set of edges, and wherein the matching graph received by the decoder is updated based on a predicted probability distribution of a lost qubit. In some embodiments, the method further comprises performing a measurement operation, wherein the measurement operation is state selective. In some embodiments, the measurement operation comprises a qubit to be measured to electromagnetic energy, wherein the electromagnetic energy is configured to selectively drive the qubit to be measured from an initial state to an excited state in a presence of an applied magnetic field, wherein a selectivity of a transition to the excited state is based at least in part on a strength of the applied magnetic field. In some embodiments, the method further comprises determining that the qubit to be measured was in the initial state, wherein the determining is based at least in part on the qubit returning to the initial state by emission of a photon in response to the electromagnetic energy.

In some embodiments, the qubit is an atom, and (b) is implemented using optical tweezers,

In some embodiments, the decoder comprises union find, tensor network decoder, belief propagation with ordered statistics decoder, maximum likelihood decoder, or a look up table decoder. In some embodiments, the minimum weight perfect matching comprises sparse blossom or fusion blossom. In some embodiments, (a)-(d) comprise a portion of an error correcting code, wherein the error correcting code comprises a topological code. In some embodiments, the topological code is a stabilizer code. In some embodiments, the error correcting code is a surface code, a color code, a toric code, a shor style code, or a qLDPC code. In some embodiments, the color code is a Steane code. In some embodiments, the shor style code is a Bacon-shor code. In some embodiments, the qLDPC code is a hypergraph product code.

In some embodiments, (c) comprises implementing an error correction code, wherein an implementation of the error correcting code comprises a decoder, wherein the decoder is configured to receive a matching graph and to determine a set of edges, and wherein the matching graph received by the decoder is updated based on a predicted probability distribution of a lost qubit. In some embodiments, the decoder is configured to receive a matching graph and to determine a set of edges, and wherein the matching graph received by the decoder is updated based on a predicted probability distribution of a lost qubit. In some embodiments, the error correcting code is a stabilizer code. In some embodiments, each node in the matching graph corresponds to a change-of-value of a particular stabilizer and wherein pairs of nodes are connected by edges corresponding to possible physical errors. In some embodiments, the edges are weighted based on the likelihood of a particular error occurring. In some embodiments, atom loss is treated as a gate error that occurs with a probability of 50%.

In another aspect, the present disclosure provides a method for error corrected quantum computation. The method may comprise implementing an error correction code, wherein an implementation of the error correcting code comprises a decoder, wherein the decoder is configured to receive a matching graph and to determine a set of edges, and wherein the matching graph received by the decoder is updated based on a predicted probability distribution of a lost qubit.

In another aspect, the present disclosure provides a method for error corrected quantum computation. The method may comprise providing a plurality of qubits; and implementing an error correction code, wherein an implementation of the error correcting code comprises a decoder, wherein the decoder is configured to receive a matching graph and to determine a set of edges, and wherein the matching graph received by the decoder is updated based on a predicted probability distribution of a lost qubit.

In some embodiments, the error correction code comprises an operation in which a two-qubit interaction between a qubit and a lost qubit has an effect of a Pauli operation or an identity operation on the qubit. In some embodiments the qubit is a non-lost qubit. In some embodiments the qubit is a lost qubit. In some embodiments, the method further comprises prior to (b), (i) identifying that a qubit has been lost; (ii) replacing the qubit; and (iii) reimplementing the qubit into the circuit. In some embodiments, the method further comprises subsequent to (b): (iv) flagging measurements taken while the qubit was missing as untrustworthy.

In some embodiments, identifying in (i) comprises using a plurality of swap gates. In some embodiments a swap gate within the plurality of swap gates is implemented as a plurality of CNOT gates. In some embodiments, the method further comprises measuring alternating atoms in a lattice; performing the plurality of swap gates to transfer data stored on data qubits to ancilla qubits; and measuring the swapped data qubits to identify one or more lost atoms. In some embodiments, identifying in (i) comprises using a modified knock-knock protocol, wherein the modified knock-knock protocol comprises: providing a first atom to be probed using a second atom, wherein the second atom is an ancilla qubit; preparing the second atom in a |+>state; applying a modified control-Z gate between the first atom and the second atom based on a Rydberg interaction; and rotating the second qubit back to a computational basis and performing a measurement. In some embodiments, reimplementing in (iii) comprises (a) use of a decoder algorithm, wherein the decoder algorithm takes in a graph and determines a set of edges.

In some embodiments, prior to (a) the method comprises updating a matching graph passed to the decoder algorithm based on a predicted probability distribution of a lost qubit replaced in (ii). In some embodiments, reimplementing in (iii) comprises use of a minimum-weight perfect matching decoder algorithm. In some embodiments, the method further comprises updating a matching graph passed to the minimum-weight perfect matching decoder algorithm based on a predicted probability distribution of a lost qubit replaced in (ii). In some embodiments, the method further comprises: if an ancilla qubit is lost, updating the matching graph so that a node involving the ancilla qubit is connected by edges corresponding to the predicted probability distribution; and if a data qubit is lost, updating the matching graph by assigning the predicted probability distribution to each node involving the data qubit. In some embodiments, each node involving the ancilla qubit is updated.

In some embodiments, (a)-(b) are performed during a quantum computation circuit. In some embodiments, (a)-(b) are performed without measurement of each or a plurality of data qubits. In some embodiments, (a)-(b) are performed substantially without loss of coherence of each or a plurality of data qubits. In some embodiments, the method further comprises subsequent to (b) flagging measurement taken during a window of time that includes a time when the lost qubit was missing as untrustworthy.

In some embodiments, the plurality of qubits comprises trapped atom qubits. In some embodiments, the trapped atom qubits comprise neutral atom qubits. In some embodiments, the neutral atom qubits comprise a Group II element or a Group II-like element. In some embodiments, the Group II element or a Group II-like element comprises Ytterbium, Rubidium, Cesium, or Strontium. In some embodiments, the plurality of qubits comprises qubit states comprising nuclear spin states on the ¹S₀ manifold. In some embodiments, the two-qubit interaction comprises an excitation of a nuclear spin state of a neutral atom to a Rydberg state of the neutral atom.

In some embodiments, the method further comprises performing a measurement operation, wherein the measurement operation is state selective. In some embodiments, the measurement operation comprises applying electromagnetic energy to a qubit to be measured, wherein the electromagnetic energy is configured to selectively drive the qubit to be measured from an initial state to an excited state in a presence of an applied magnetic field, wherein a selectivity of a transition to the excited state is based at least in part on a strength of the applied magnetic field. In some embodiments, the method further comprises determining that the qubit to be measured was in the initial state, wherein the determining is based at least in part on the qubit returning to the initial state by emission of a photon in response to the electromagnetic energy.

In some embodiments, the plurality of qubits comprises atomic qubits, and wherein an atom replacement operation is implemented using optical tweezers. In some embodiments, the decoder comprises union find, tensor network decoder, belief propagation with ordered statistics decoder, maximum likelihood decoder, or a look up table decoder. In some embodiments, the decoder comprises minimum weight perfect matching. In some embodiments, the decoder comprises sparse blossom or fusion blossom. In some embodiments, the error correcting code comprises a topological code. In some embodiments, the topological code is a stabilizer code. In some embodiments, the error correcting code is a surface code, a color code, a toric code, a shor style code, or a qLDPC code. In some embodiments, the color code is a Steane code. In some embodiments, the shor style code is a Bacon-shor code. In some embodiments, the qLDPC code is a hypergraph product code. In some embodiments, each node in the matching graph corresponds to a change-of-value of a particular stabilizer and wherein pairs of nodes are connected by edges corresponding to possible physical errors. In some embodiments, the edges are weighted based on the likelihood of a particular error occurring. In some embodiments, atom loss is treated as a gate error that occurs with a probability of 50%.

In another aspect, the present disclosure provides a system for error corrected quantum computing. The system may comprise an error correction code, wherein an implementation of the error correcting code comprises a decoder, wherein the decoder is configured to receive a matching graph and to determine a set of edges, and wherein the matching graph received by the decoder is updated based on a predicted probability distribution of a lost qubit.

In some embodiments, the error correction code comprises an operation in which a two-qubit interaction between a qubit and a lost qubit has an effect of a Pauli operation or an identity operation on the qubit. In some embodiments, the qubit is a non-lost qubit. In some embodiments, the qubit is a lost qubit.

In some embodiments, the system further comprises a processor configured to implement an error correcting code. In some embodiments, the processor is further configured to provide instructions to a non-classical computing system, wherein the non-classical computing system is configured to implement the instructions to: (i) identify that a qubit has been lost; (ii) replace the qubit; and (iii) reimplement the qubit into the circuit. In some embodiments, the processor is further configured to (iv) flag measurements taken while the qubit was missing as untrustworthy. In some embodiments, (i) comprises using a plurality of swap gates. In some embodiments, a swap gate within the plurality of swap gates is implemented as a plurality of CNOT gates. In some embodiments, the processor is further configured to provide instructions to the non-classical computing system to measure alternating atoms in a lattice; perform the plurality of swap gates to transfer data stored on data qubits to ancilla qubits; and measure the swapped data qubits to identify one or more lost atoms.

In some embodiments, (i) comprises using a modified knock-knock protocol, wherein the modified knock-knock protocol comprises: providing a first atom to be probed using a second atom, wherein the second atom is an ancilla qubit; preparing the second atom in a |+>state; applying a modified control-Z gate between the first atom and the second atom based on a Rydberg interaction; and rotating the second qubit back to a computational basis and performing a measurement. In some embodiments, (iii) comprises (A) use of a decoder algorithm, wherein the decoder algorithm takes in a graph and determines a set of edges. In some embodiments, prior to (A) the processor is further configured to update a matching graph passed to the decoder algorithm based on a predicted probability distribution of a lost qubit replaced in (ii). In some embodiments, (iii) comprises use of a minimum-weight perfect matching decoder algorithm. In some embodiments, the processor is further configured to update a matching graph passed to the minimum-weight perfect matching decoder algorithm based on a predicted probability distribution of a lost qubit replaced in (ii). In some embodiments, the processor is further configured to: if an ancilla qubit is lost, update the matching graph so that a node involving the ancilla qubit is connected by edges corresponding to the predicted probability distribution; and if a data qubit is lost, update the matching graph by assigning the predicted probability distribution to each node involving the data qubit. In some embodiments, each node involving the ancilla qubit is updated.

In some embodiments, the error correcting code is configured to be implemented during a quantum computation circuit. In some embodiments, the error correcting code is configured to be implemented without measurement of each or a plurality of data qubits. In some embodiments, the error correcting code is configured to be implemented substantially without loss of coherence of each or a plurality of data qubits. In some embodiments, processor is further configured to flag measurements taken during a window of time that includes a time when the lost qubit was missing as untrustworthy. In some embodiments, the system further comprises a non-classical computing system, wherein the non-classical computing system comprises trapped atom qubits. In some embodiments, the trapped atom qubits comprise neutral atom qubits. In some embodiments, the neutral atom qubits comprise a Group II element or a Group II-like element. In some embodiments, the Group II element or a Group II-like element comprises Ytterbium, Rubidium, Cesium, or Strontium. In some embodiments, the plurality of qubits comprises qubit states comprising nuclear spin states on the ¹S₀ manifold. In some embodiments, the two-qubit interaction comprises an excitation of a nuclear spin state of a neutral atom to a Rydberg state of the neutral atom.

In some embodiments, the processor is further configured to provide instructions to the non-classical computing system to perform a measurement operation, wherein the measurement operation is state selective. In some embodiments, the measurement operation comprises applying electromagnetic energy to a qubit to be measured, wherein the electromagnetic energy is configured to selectively drive the qubit to be measured from an initial state to an excited state in a presence of an applied magnetic field, wherein a selectivity of a transition to the excited state is based at least in part on a strength of the applied magnetic field. In some embodiments, the processor is further configured to determine that the qubit to be measured was in the initial state based at least in part on the qubit returning to the initial state by emission of a photon in response to the electromagnetic energy.

In some embodiments, the system further comprises a non-classical computing system, wherein the non-classical computing system comprises a plurality of qubits, wherein the plurality of qubits comprises atomic qubits, and wherein an atom replacement operation is implemented using optical tweezers. In some embodiments, the decoder comprises union find, tensor network decoder, belief propagation with ordered statistics decoder, maximum likelihood decoder, or a look up table decoder. In some embodiments, the decoder comprises minimum weight perfect matching. In some embodiments, the decoder comprises sparse blossom or fusion blossom. In some embodiments, the error correcting code comprises a topological code. In some embodiments, the topological code is a stabilizer code. In some embodiments, the error correcting code is a surface code, a color code, a toric code, a shor style code, or a qLDPC code, In some embodiments, the color code is a Steane code. In some embodiments, the shor style code is a Bacon-shor code. In some embodiments, the qLDPC code is a hypergraph product code. In some embodiments, each node in the matching graph corresponds to a change-of-value of a particular stabilizer and wherein pairs of nodes are connected by edges corresponding to possible physical errors. In some embodiments, the edges are weighted based on the likelihood of a particular error occurring. In some embodiments, atom loss is treated as a gate error that occurs with a probability of 50%.

In another aspect, the present disclosure provides a method for error corrected quantum computation. The method may comprise: (a) identifying that a qubit has been lost; (b) replacing the qubit; (c) reimplementing the qubit into the circuit; and (d) flagging measurements taken while the qubit was missing as untrustworthy.

In some embodiments, identifying in (a) comprises using a plurality of swap gates. In some embodiments, a swap gate within the plurality of swap gates is implemented as a plurality of CNOT gates. In some embodiments, the method further comprises measuring alternating atoms in a lattice; performing the plurality of swap gates to transfer data stored on data qubits to ancilla qubits; and identifying measuring the swapped data qubits to identify one or more lost atoms.

In some embodiments, identifying in (a) comprises using a modified knock-knock protocol, wherein the modified knock-knock protocol comprises: providing an first atom to be probed using a second atom, wherein the second atom is an ancilla qubit; preparing the second atom in a |+>state; applying a modified control-Z gate between the first atom and the second atom based on a Rydberg interaction; and rotating the second qubit back to a computational basis and performing a measurement.

In some embodiments, reimplementing in (c) comprises use of a minimum-weight perfect matching decoder algorithm. In some embodiments, the method further comprises updating a matching graph passed to the minimum-weight perfect matching decoder algorithm based on a predicted probability distribution of a lost qubit replaced in (b). In some embodiments, the method further comprises if an ancilla qubit is lost, updating the matching graph so that a node involving the ancilla qubit is connected by edges corresponding to the predicted probability distribution, and if a data qubit is lost, updating the matching graph by assigning the predicted probability distribution to each edge connecting the data qubit to each connected ancilla qubit.

Another aspect of the present disclosure provides a system comprising one or more computer processors and computer memory coupled thereto. The computer memory comprises machine executable code that, upon execution by the one or more computer processors, implements any of the methods above or elsewhere herein.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure.

Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “Figure”and “FIG.”herein), of which:

FIG. 1 is a flowchart of an example method for error corrected quantum computation.

FIG. 2A is a schematic of an energy level diagram illustrating a case in which a two-qubit interaction between a qubit and a lost qubit has an effect of a Pauli operation or an identity operation on the qubit.

FIG. 2B is a flowchart of an example method for error corrected quantum computation based on updating a matching graph received by a decoder.

FIG. 3A is a flowchart of an example of a method for identifying atom loss during an error correcting code where the error correcting code comprises executing a series of SWAP gates.

FIG. 3B is a diagram of an operation of a method for implementing an error correcting code comprising executing a series of SWAP gates between the ancilla qubits and the data qubits.

FIG. 4 is a flowchart of an example of a method for implementing an error correcting code which accounts for atom loss wherein the error correcting code comprises a modified knock-knock protocol.

FIG. 5A is a diagram of a matching graph indicating a lost ancilla qubit.

FIG. 5B is a diagram of a matching graph indicating a lost data qubit.

FIG. 5C is a flowchart of a method for reimplementing a qubit.

FIG. 6A shows a system for error corrected quantum computing that is programmed or otherwise configured to implement methods provided herein.

FIG. 6B shows a computer system that is programmed or otherwise configured to implement methods provided herein.

FIG. 7A is a plot of simulation data showing a plot of physical error rate versus logical error probability for a model which considers atom loss.

FIG. 7B is a plot of simulation data showing a plot of physical error rate versus logical error probability for a model which does not consider atom loss.

FIG. 7C is an overlay of the data in FIG. 7A and FIG. 7B.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

Whenever the term “at least,” “greater than,” or “greater than or equal to” precedes the first numerical value in a series of two or more numerical values, the term “at least,” “greater than” or “greater than or equal to” applies to each of the numerical values in that series of numerical values. For example, greater than or equal to 1, 2, or 3 is equivalent to greater than or equal to 1, greater than or equal to 2, or greater than or equal to 3.

Whenever the term “no more than,” “less than,” or “less than or equal to” precedes the first numerical value in a series of two or more numerical values, the term “no more than,” “less than,” or “less than or equal to” applies to each of the numerical values in that series of numerical values. For example, less than or equal to 3, 2, or 1 is equivalent to less than or equal to 3, less than or equal to 2, or less than or equal to 1.

Certain inventive embodiments herein contemplate numerical ranges. When ranges are present, the ranges include the range endpoints. Additionally, every sub range and value within the range is present as if explicitly written out.

The term “about” or “approximately” may mean within an acceptable error range for the particular value, which will depend in part on how the value is measured or determined, e.g., the limitations of the measurement system. For example, “about” may mean within 1 or more than 1 standard deviation, per the practice in the art. Alternatively, “about” may mean a range of up to 20%, up to 10%, up to 5%, or up to 1% of a given value. Where particular values are described in the application and claims, unless otherwise stated the term “about” meaning within an acceptable error range for the particular value may be assumed.

### Methods for Error Corrected Quantum Computation

Systems and methods disclosed herein may generally relate to qubit loss during error correction. Within qubit loss during error correction, there may be at least two general pieces. Systems and methods described herein may be directed to detecting qubit loss without destroying the data stored on the qubits. Instead of appearing as a gate measurement error, if a qubit is lost, the data that would be there is absent rather than incorrect. Systems and methods disclosed herein may be directed to identifying when an error is caused by a missing qubit. Systems and methods described herein may also be directed to modifying the decoder to handle loss events. For example, the error correcting code may be directed to updating the calculation to address for error. In some cases, knowing about the error may be needed in order to implement error correcting code. However, in other cases, the error correcting code may be modified to account for missing data without explicit knowledge that qubit is lost.

Systems and methods disclosed herein may not generally modify the topology of the underlying surface code. Systems and methods described herein may improve upon methods of detecting atom loss by compressing the underlying protocol. Systems and methods disclosed herein may allow for loss detection between cycles (or possibly less frequently) rather than after every gate. Systems and methods disclosed herein may address un-induced erasure errors in addition to or alternatively to gate induced erasure errors.

Systems and methods of the present disclosure may improve upon other procedures at least because systems and methods of the present disclosure may not comprise or require operations that modify the topology of the underlying surface code. In some cases, the underlying surface code may be unchanged. Instead, a matching graph passed to a decoder algorithm may be updated to account for a predicted probability distribution of a lost qubit. Because the matching graph passed to the decoder is updated, the underlying decoder may also be unchanged. Because the decoder is unchanged, the error correcting code may also not be changed. Accordingly, methods and systems of the present disclosure may be used without changing the underlying surface code. Similarly, because changes to the underlying decoder and surface code are not needed, methods and systems of the present disclosure may be used with a wide variety of decoders and surface codes.

In some cases, tracking syndrome measurements may be used to detect loss events (e.g., defects). See, e.g., Siegel, A. et al., Adaptive Surface Code for Quantum Error Correction in the Presence of Temporary or Permanent Defects, arXiv:2211.08468v1 [quant-ph] 15 Nov. 2022, available at https://arxiv. org/pdf/2211.08468.pdf, which is incorporated by reference herein in its entirety.

In some cases, gate induced erasure errors may be addressed by error correction. See e.g., Wu, Y., et al., Erasure conversion for fault-tolerant quantum computing in alkaline earth Rydberg atom arrays, Nat. Comms. Vol 13, P. 4657 (2022), which is incorporated by reference herein in its entirety. In the above, the atoms may still be present. Rather than addressing missing atoms or qubits, the above referenced application may turn gate errors into erasure errors.

In some cases, noise structure in the hardware may be used for error correction. See e.g., Shay, K., et al., High threshold codes for neutral atom qubits with biased erasure errors, arXiv:2302.03063v1 [quant-ph] 6 Feb 2023), which is incorporated by reference herein in its entirety. Similar to Wu, the atoms may still be present. Rather than addressing missing atoms or qubits, the above referenced application may tum gate errors into erasure errors.

Error Correction—Quantum error correction is a procedure for encoding quantum information in a distributed manner across many quantum systems in such a way that the information to be stored is protected from localized errors on the constituent systems, provided that these errors are sufficiently sparse. In some cases, the information to be stored and the constituent systems are both two-level quantum systems, or qubits. The information to be protected is encoded across many physical qubits, forming one or more logical qubits.

The process of detecting and correcting errors on the logical qubits amounts to measuring parities of a predetermined set of operators that act on the physical qubits and using the measured parities to diagnose and correct errors. In a simple example, a parity measurement checks the equality of two qubits to return a true or false answer, which can be used to determine whether a correction needs to occur. Additional measurements can be made for a system greater than two qubits. Since the physical qubits cannot be measured directly without collapsing the state of the logical system, these parities are measured using ancillary qubits (i.e., ancilla). Thus, there may be two types of physical qubits: data qubits on which the logical information is stored and ancilla qubits which are used to extract the desired parity checks.

In practice, an error correction cycle consists of a sequence of gates to transfer parity values onto the ancilla qubits followed by measurement of the ancilla qubits. This process is known as syndrome extraction. Errors can occur at any point during the syndrome extraction process, including during readout of the ancilla qubits.

One method of error correction (Shor style) uses repeated rounds of syndrome extraction to overcome readout error and build confidence about the state of the system. The extracted syndrome information is then passed to a decoder to determine which errors have occurred and which corrections need to be applied. The decoding problem is commonly represented as a weighted graph or hypergraph. In this setting, each node in the graph corresponds to a collection of syndrome measurements. Such a collection of syndrome measurements is called a detector. Edges or hyperedges in the graph correspond to errors, and the weight of an edge corresponds to the likelihood of that error occurring. The occurrence of a given error may be expected cause the parity of all associated detectors to flip. The decoding problem can then be stated as follows: given a set of detectors (nodes) whose parities differ from those expected in the absence of error, determine the most likely set of physical errors (edges) that could cause the observed detections.

Error Correction with Atom Loss—Quantum computers based on trapped atoms may be subject to errors generated by loss of qubit. In trapped atom quantum computers, a qubit may comprise atom in an array. That atom may be a neutral atom or an ion. Error correcting code may generally employ repeated implementations of the circuit implementing the quantum computation. As the circuit is implemented and re-implemented statistics may be generated on what errors occurred. However, error correcting code implemented on systems with qubit loss may generally different than other systems. For example, a non-qubit loss error may be a gate error. Similarly, loss of coherence may be expressed as a gate error. In a gate error or an error that is similar to a gate error, there is a comparatively smaller set of possible error values because the result of a gate error is like a measurement of the system. In some cases, the atom loss rate may be similar or larger than the gate error rate, thus it may be helpful to provide improved methods of correcting for atom loss.

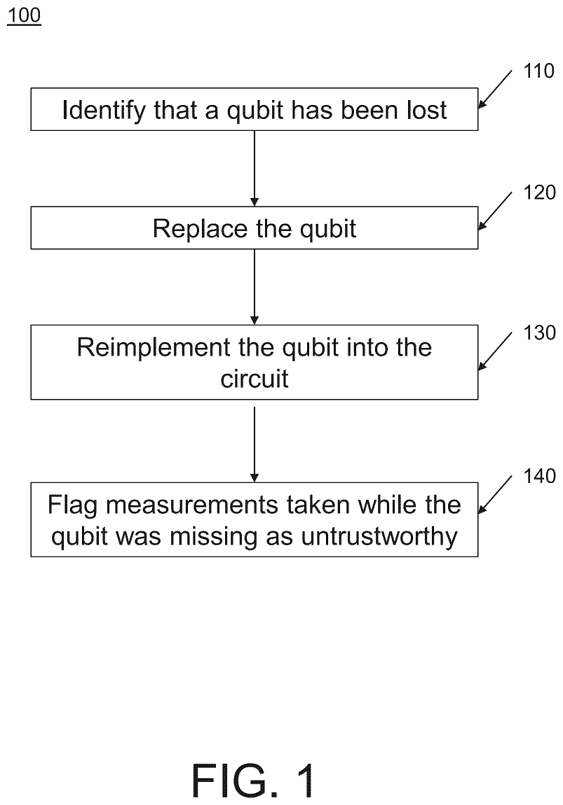

FIG. 1 is a flowchart of an example method 100 for error corrected quantum computation. In some cases, an error correcting code which accounts for qubit loss may comprise identifying that a qubit has been lost (110); replacing the qubit (120); reimplementing the qubit into the circuit which may be in the wrong state when it is replaced (130); and flagging measurements taken while the qubit was missing as untrustworthy (140).

Referring to FIG. 1, at an operation 110 of a method 100 of error correction with atom loss, atom loss can be detected. For example, atom loss may be detected at the end of each syndrome extraction cycle. Methods of detecting atom loss are described herein with respect to the section “Identifying Qubit Loss.” At an operation 120 of a method 100 of error correction with atom loss, once a qubit is identified as lost it may be replaced with a new qubit. The new qubit may be, at least initially, in a random state.

At an operation 130 of a method 100 of error correction with atom loss, the qubit may be reimplemented into the circuit. In some cases, operation 130 comprises use of a decoder algorithm. The decoder algorithm may take in a graph and determine a set of edges. In some cases, operation 130 comprises prior implementing the decoder algorithm, updating a matching graph passed to the decoder algorithm based on a predicted probability distribution of a lost qubit replaced in operation 120. Methods of updating the decoder algorithm are described herein with respect to the section “Modifying the decoding algorithm.”

In systems not subject to atom loss, the errors may be discrete Pauli errors on physical qubits. But when qubits are stored on atoms, the atoms—and therefore the qubits they contain—can be lost. The effect on syndrome extraction in the presence of loss depends on hardware details. For neutral atoms using Rydberg gates, the effect of atom loss manifests as a non-interaction instead of a two-qubit gate. Practically, two-qubit interactions between a lost and present atom may be treated as affecting an Identity gate on the present atom.

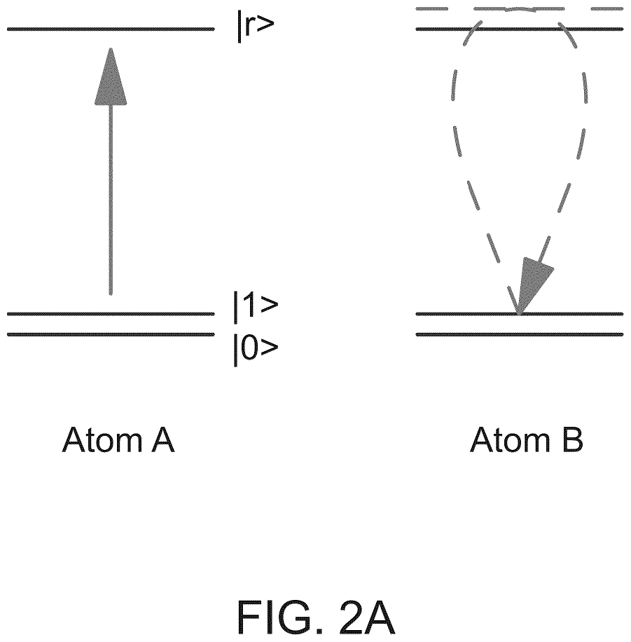

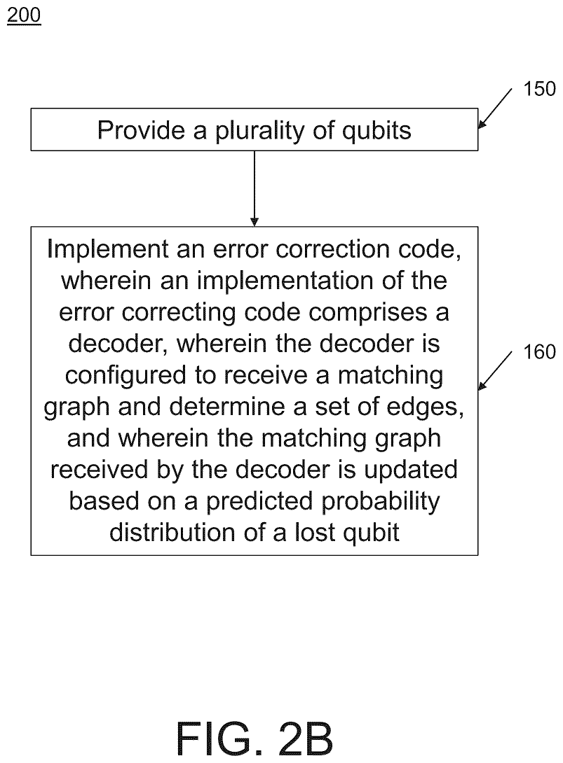

FIG. 2A is a schematic of an energy level diagram illustrating a case in which a two-qubit interaction between a qubit and a lost qubit has an effect of a Pauli operation or an identity operation on the qubit. As shown, atom A and atom B may be neighboring qubits. The qubits may be trapped ion qubits. The qubits may be trapped atom qubits. As shown, one qubit acquires a phase conditioned on state-selective excitation of the other. In some cases, the state selective excitation is from a state |1>to a state|r>.

In some cases, a state |r> is a Rydberg state. In some cases, a state |r> is a Rydberg state of a neutral atom qubit. If at A is excited to a Rydberg state, then Atom B (if present) experiences a shift due to the Rydberg interaction. In an example, an optical excitation may be tuned to a frequency difference between the |1>state and the Rydberg state. If Atom A is in state |1>, then Atom A is at least transiently driven to the Rydberg state and Atom B (if present) experiences a shift due to the Rydberg interaction. If Atom B is not present and Atom A is in state |1>, there is no Shift to Atom B. If Atom A is in state |0> and Atom B is present, then the energy gap is too large, and nothing happens to Atom A or Atom B. If Atom A is in state |0> and Atom B is not present, then the energy gap is still too large, and nothing happens to Atom A or Atom B (which isn't present). Accordingly, two-qubit interactions between a lost and present atom may be treated as affecting an Identity gate on the present atom. While this example describes a case where the two-qubit interaction with a lost atom affects the Identity operation, methods and system of the present disclosure also work when the two-qubit interaction with a lost atom affects a Pauli operation. A Pauli operation may comprise a Pauli-X gate, a Pauli-Y gate, or a Pauli-Z gate. For example, the Pauli-X gate is a single-qubit rotation the pi radians around the X-axis. For example, the Pauli-Y gate is a single-qubit rotation the pi radians around the Y-axis. For example, the Pauli-Z gate is a single-qubit rotation the pi radians around the Z-axis. A rotation about an axis of two pi radians is an Identity operation.

The above works similarly if Atom A is also a lost qubit. In some cases, the qubit is a non-lost qubit. In some cases, the qubit is a lost qubit. For example, when the qubit is a lost qubit, a two-qubit gate between two lost qubits similarly affects the identity. Because the two-qubit operation between an atom a lost atom affects the identity. The protocol does not propagate errors (to first order) forward in time. For example, if the two-qubit operation is imperfect. The operation may propagate forward higher order errors in time.

The two-qubit gate property described with respect to FIG. 2A may be used to modify the decoder.

FIG. 2B is a flowchart of an example method 200 for error corrected quantum computation based on updating a matching graph received by a decoder. At an operation 210, the method may comprise providing a plurality of qubits. Systems and methods described herein may be directed to detecting qubit loss without destroying the data stored on the qubits. For example, it may be difficult to determine that a qubit has been lost and update the decoder in the middle of circuit.

At an operation 220, the method may comprise implementing an error correction code, wherein an implementation of the error correcting code comprises a decoder, wherein the decoder is configured to receive a matching graph and determine a set of edges, and wherein the matching graph received by the decoder is updated based on a predicted probability distribution of a lost qubit.

Systems and methods disclosed herein may be used with various decoders. An error correcting scheme (e.g., an implementation of an error correcting code) of the present disclosure may comprise a decoder. A decoder may decode which errors occurred on which qubits. Once identified, these errors can be tracked and the information used to correct subsequent measurement outcomes using the classical control software. In some cases, an implementation of the error correction code comprises an operation in which a two-qubit interaction between a qubit and a lost qubit has an effect of a Pauli operation or an identity operation on the qubit.

In an example, a round of error correction code may comprise performing two-qubit operations between data qubits an ancilla qubits. The two-qubit operations may comprise a portion of a round of syndrome extraction.

If an ancilla qubit is lost, no change may occur to the data qubits because a two-qubit gate on a qubit and a lost qubit affects the Identity. However, since the ancilla qubit is lost, the round of syndrome extraction associated with that ancilla qubit does not provide a reliable syndrome value for that particular round of syndrome extraction. To handle this in decoding, the missing syndrome bit may be assigned a value associated with a random state. In the matching graph, an edge may be added to each detector containing the missing syndrome value and an edge weight may be assigned which corresponds to a 50% probability of error. (This is like telling the decoder, “Do not trust these syndrome values.”)

If a data qubit is lost, none of the syndromes in which it participates can be viewed as trustworthy. Thus, for each syndrome measurement containing a lost data qubit, the above process may be repeated for each ancilla with which the lost data qubit was intended to interact. Accordingly, because multiple ancilla qubits may be associated with the lost data qubit, a larger number of ancilla measurements may provide unreliable syndrome data depending upon particular error correcting code. For example, in a surface code, four edges may be created. In another example, in a color code, three edges may be created.

The methods of updating the decoder described herein may not depend on the type of atom, the type of qubit, the type of error correction code, or the specific decoder used in the error correcting code. If the two qubit-gate operation affects the Identity or a Pauli operation, then the matching graph passed to the decoder may be updated as described herein.

At an operation 140 of a method 100 of error correction with atom loss, measurements taken while the qubit was missing may be flagged as untrustworthy. In some cases, operation 140 comprises flagging measurement taken during a window of time that includes a time when the qubit was missing as untrustworthy. For example, a window of time may comprise a round of syndrome measurements. It may not be necessary to know exactly which measurements were taken while the atom was lost, only what set of measurements were taken during a window of time that includes a lost atom.

The methods and systems described herein may be allow for identification of a lost qubit substantially without stopping the circuit. For example, if a set of measurements are flagged as untrustworthy, the circuit may continue with other measurements and return to retake the measurements that were untrustworthy. For example, if a data qubit is flagged as missing, the circuit may continue on other qubits while the atom is replaced and a portion of a circuit comprising that qubit may be reimplemented.

The methods and systems described herein may allow for identification of a lost qubit and replacement of the lost qubit without measurement of each or a plurality of data qubits. As noted above, a missing qubit may be identified in a round of syndrome measurements without measurement of the data qubit. Accordingly, an atom identified as missing may be replaced and a circuit may be continued without measurement of a data qubit.

The methods and systems described herein may be allow for identification of a lost qubit without loss of coherence of each or a plurality of data qubits. As noted, because the error correcting code uses measurements of syndrome qubits to identify atom loss, a data qubit may not need to be measured during around error correction. Systems and methods of the present disclosure may allow for continuous correction of atom loss. Systems and methods of the present disclosure may allow for correction of atom loss mid-circuit.

### Identifying Qubit Loss

The present disclosure provides at least two methods of identifying qubit loss; however, various methods of identifying qubit loss may be integrated into methods and systems of the present disclosure. An example method of implementing an error correcting code which accounts for atom loss may comprise implementing a plurality of SWAP gates. Another example method of implementing an error correcting code which accounts for atom loss may comprise a modified knock-knock protocol.

SWAP Gate Method—In some cases, identifying that a qubit has been lost at operation 110 of the method 100 comprises using a plurality of swap gates. In some cases, a swap gate within the plurality of swap gates is implemented as a plurality of CNOT gates. In some cases, the method further comprises measuring alternating atoms in a lattice; performing the plurality of SWAP gates to transfer data stored on data qubits to ancilla qubits; and measuring the swapped data qubits to identify one or more lost atoms. For example, measuring alternating atoms in a lattice may comprise measuring each or a plurality of ancilla qubits to arrive at syndrome information. For example, performing a plurality of SWAP gates to transfer data stored on data qubits to ancilla qubits may comprise executing a series of SWAP gates between the ancilla qubits and the data qubits. For example, measuring the swapped data qubits to identify one or more lost atoms may comprise measuring each or a plurality of data qubits and checking for unexpected errors.

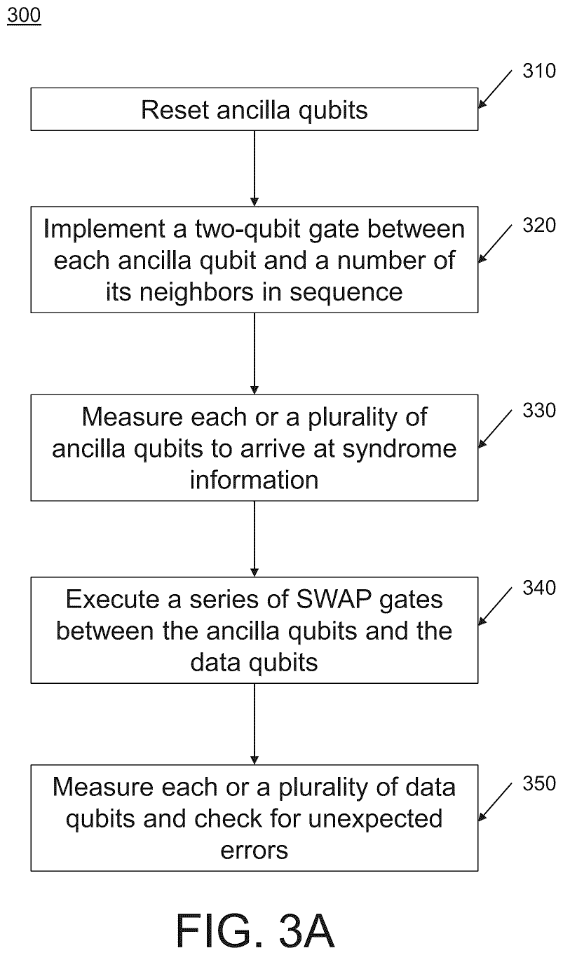

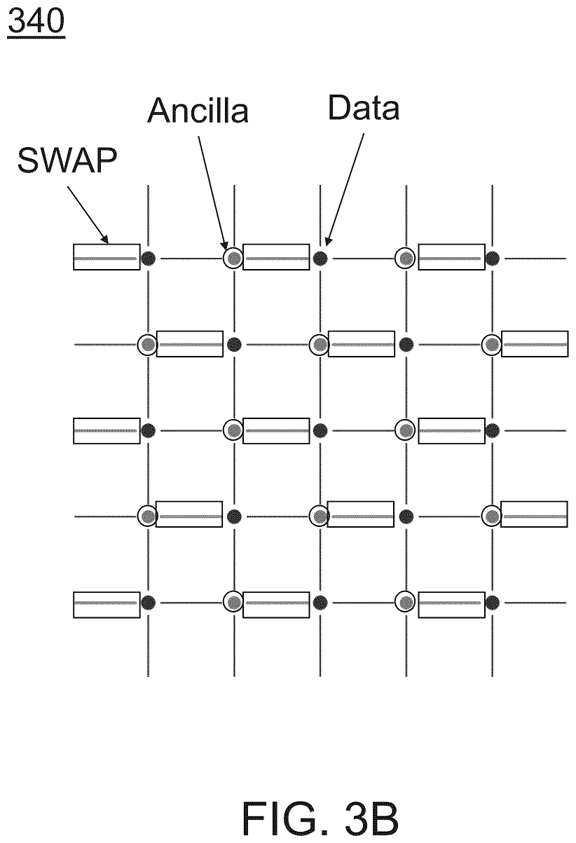

In an example method of detecting lost qubits, a lost qubit may be identified using a series of swap gates. FIG. 3A is a flowchart of an example of a method 300 for implementing an error correcting code which accounts for atom loss. FIG. 3B is a diagram of an operation 340 of a method 300 for implementing an error correcting code comprising executing a series of SWAP gates between the ancilla qubits and the data qubits. A SWAP gate may transfer the information between a pair qubits. For example, a SWAP gate may transfer the information from an ancilla to a data qubit.

In some cases, alternating atoms in the lattice may be measured (the ancilla qubits, e.g., circled grey atoms). Then, SWAP gates may be performed to transfer the data stored on the data qubits to the ancilla qubits. As a result of this operation, the ancilla qubits from the previous round of syndrome extraction become the data qubits of the subsequent round. Following the swap gates, the former data qubits may be measured to identify lost atoms. Lost atoms may then be replaced.

Operation 310 of a method 300 may comprise resetting the ancilla qubits. In the cases of trapped atom quantum computing, the resetting may comprise optically pumping one or more atoms to a particular state. The optical pumping may be an incoherent process. The particular state may be a qubit state, e.g., a |1>state or a |0>state, In some cases, optical pumping comprises cyclically pumping the qubit from a first state to a second state. For example, the qubit may be coherently pumped from a first state to a second state. When the qubit is cyclically pumped, the qubit may be undergoing repeated excitation and decay between the upper state and the lower state. In an example, the optical pumping process may comprise a transition from a |1>state or a |0>state to an excited state. For example, the optical pumping process may comprise a transition from a nuclear spin state in the ¹S₀ manifold to a state in the ³P₁ or ³P₀ manifold of ⁸⁷Rb, ⁸⁷Sr, ¹⁷¹Yb, etc. In an example, the optical pumping process may comprise a Raman transition from a |1>state or a |0>state to a virtual state. For example, the optical pumping process may comprise a transition from a nuclear spin state in the ¹S₀ manifold to a virtual state below the ³P₁ or ³P₀ manifold. Optical pumping may serve to reset the qubit into a |1>state or a |0>state.

Operation 320 of a method 300 may comprise implementing a two-qubit gate between each ancilla qubit and four of its neighbors in sequence. As noted above, an error correction sequence may comprise a two-qubit interaction. For example, a round of error correction code may comprise performing two-qubit operations between data qubits an ancilla qubits. The two-qubit operations may comprise a portion of a round of syndrome extraction. As noted with respect to FIG. 2A, the two-qubit interaction between a qubit and a lost qubit may have an effect of a Pauli operation or an identity operation on the qubit. In some cases, a two-qubit gate between a qubit and four of its neighbors are each applied in series.

Operation 330 of a method 300 may comprise measuring each or a plurality of ancilla qubits to arrive at syndrome information. As each ancilla qubit is measured it is possible that some syndrome data is lost due to a lost atom. In some cases, methods of error correction which do not account for atom loss may stop here. As the ancillas are measured, it may be possible that some syndrome data is lost. For example, syndrome data may be lost due to lost syndrome qubits, e.g., lost syndrome atoms. Syndrome data qubits identified at this stage may be replaced at an atom replacement step herein.

In some cases, a measurement operation herein is a state selective measurement operation. Example measurement operations are described herein with respect to the section “Measurement Operation.”

Operation 340 of a method 300 may comprise executing a series of swap gates between the ancilla qubits and the data qubits. The SWAP gates may be generally implemented as a series of CNOT gates rather than as a standard SWAP. The series of CNOT gates may comprise three CNOT gates. In some cases, the swaps may be single site moves; however, in some cases, a greater distance SWAP may be executed. A SWAP gate may be distinct from physically moving qubits. For example, SWAP gate may change the information carried by the swapped qubits without moving the atoms themselves.

FIG. 3B is a diagram of an operation 340 of a method 300 for implementing an error correcting code comprising executing a series of SWAP gates between the ancilla qubits and the data qubits. A SWAP gate may transfer the information between a pair qubits. For example, a SWAP gate may transfer the information from an ancilla to a data qubit. As shown, a plurality of SWAP gates may be implemented across the array. For example, an entire array may undergo a series of SWAP operations between neighboring qubits. For example, a portion of an array may undergo a series of SWAP operations between neighboring qubits. As a result of this operation, the ancilla qubits from the previous round of syndrome extraction become the data qubits of the subsequent round of syndrome extraction.

Operation 350 of a method 300 may comprise measuring each or a plurality of data qubits and checking for unexpected errors. In some cases, a measurement operation herein is a state selective measurement operation. Example measurement operations are described herein with respect to the section “Measurement Operation.”

Operations 310 to 340 may be repeated. After the sequence, the error correcting code may have measured a significant fraction or all of the qubits in the array without measuring the data itself. During operations 310 to 340, lost qubits may be identified. The procedure may track which sites have atoms that are lost such that the algorithm may be updated. A qubit flagging operation may comprise an embodiment, variation, or example of operation 140 of the method 100.

Operation 350 of a method 300 may comprise qubit replacement. For example, once one or more unexpected errors are identified, an atom or atoms may be replaced. A qubit replacement operation may comprise an embodiment, variation, or example of operation 120 of the method 100. A qubit replacement operation may comprise an embodiment, variation, or example of operation 120 of the method 100. Methods of replacing a qubit are described herein with respect to the section “Qubit Replacement.”

In some cases, the qubit may be reimplemented into the circuit. A qubit reimplementing operation may comprise an embodiment, variation, or example of operation 130 of the method 100. In some cases, operation 330 comprises use of a decoder algorithm. The decoder algorithm may take in a graph and determine a set of edges. In some cases, operation 130 comprises prior implementing the decoder algorithm, updating a matching graph passed to the decoder algorithm based on a predicted probability distribution of a lost qubit replaced in operation 120. Methods of updating the decoder algorithm are described herein with respect to the section “Modifying the decoding algorithm.”

Operations 310 to 350 may be repeated. After the sequence, the error correcting code may have measured a significant fraction or all of the qubits in the array without measuring the data itself.

Operation 350 of a method 300 may comprise updating the decoding algorithm to flag measurements that are suspect due to an identified atom loss. Updating the decoding algorithm may comprise an embodiment, variation, or example of operation 220 of the method 200.

Modified Knock-Knock—In some cases, identifying at operation 110 of the method 100 comprises using a modified knock-knock protocol. A knock-knock protocol may generally comprise a two-qubit operation and some rotation operation. For example, a two-qubit operation in a knock-knock protocol may comprise a CNOT operation, such as for example, CNOT-X-CNOT described herein. For example, a two-qubit operation in a knock-knock protocol may comprise a controlled Z (CZ) operation, as described herein.

In an example, a modified knock-knock protocol may comprise providing a first atom to be probed using a second atom, wherein the second atom is an ancilla qubit; preparing the second atom in a |+>state; applying a modified control-Z gate between the first atom and the second atom based on a Rydberg interaction; and rotating the second qubit back to a computational basis and performing a measurement.

In another example method of detecting lost qubits, a lost qubit may be identified using a variant on a knock-knock protocol. A knock-knock protocol may comprise two consecutive CNOT gates which are performed on a pair of qubits with an X gate in the middle on the qubit to be probed. For example, the sequency may comprise: CNOT-X- CNOT. A CNOT gate is a two-qubit operation, where the first qubit is usually referred to as the control qubit and the second qubit as the target qubit, which is the qubit to be probed. In a CNOT gate, when the control is in a state |1>, the CNOT gate flips the state of the target. When the control is in a state |0>, the state of the target is unchanged. In the case of a probing qubit loss, the CNOT does nothing if the target qubit is not present, regardless if it starts in |0> or |1>. If the target qubit is present, the CNOT gate flips the state of the target if the control is in state |1>. An X gate is a bit flip gate, which is applied on the qubit to be probed. If the qubit to be probed is missing, the operation does nothing. If the qubit to be probed is present, the state is flipped. Thus, the CNOT-X-CNOT sequence acts like a two-qubit gate controlled by the presence of a qubit, rather than a state of the qubit. In a Rydberg variation on the procedure, the CNOT gate may comprise a Rydberg interaction. In some cases, the Rydberg interaction may make the sequence more compact.

In some cases, the knock-knock protocol may be used to detect loss without destroying the data. See, e.g., Stricker, R., et al., Deterministic Correction of Atom Loss, arXiv: 2002.09532v1 [quant-ph] 21 Feb. 2020, available at: https://arxiv. org/pdf/2002.09532.pdf, which is incorporated herein by reference in its entirety.

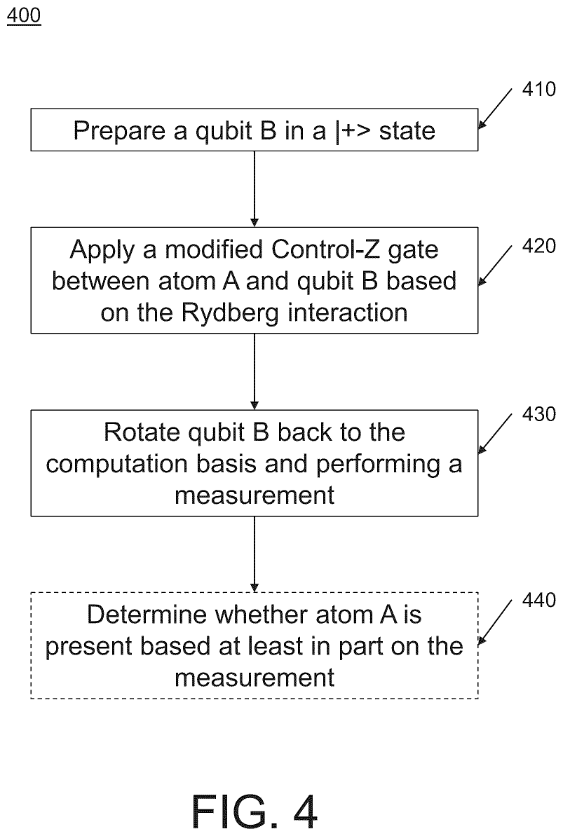

FIG. 4 is a flowchart of an example of a method 400 for implementing an error correcting code which accounts for atom loss. The method 400 may comprise a modified knock-knock protocol. Systems and method disclosed herein propose a compressed version of the knock-knock protocol. As disclosed below, the presence of one atom (Atom A) may be probed using an ancilla (Atom B). In some cases, one or both of Atom A and Atom B are qubits.

Operation 410 of a method 400 may comprise preparing qubit B in |+>state. The step of operation of preparing qubit in a |+>may comprising optical pumping. The preparing may comprise optically pumping one or more atoms to a particular state. The optical pumping may be an incoherent process. The particular state may be a qubit state, e.g., a |+>state or a |−>state. In some cases, optical pumping comprises cyclically pumping the qubit from a first state to a second state. For example, the qubit may be coherently pumped from a first state to a second state. When the qubit is cyclically pumped, the qubit may be undergoing repeated excitation and decay between the upper state and the lower state. In an example, the optical pumping process may comprise a transition from a |1>state or a |0>state (similarly, from a |+>state to a |−>state) to an excited state. For example, the optical pumping process may comprise a transition from a nuclear spin state in the ¹S₀ manifold to a state in the ³P₁ or ³P₀ manifold in ⁸⁷Rb, ⁸⁷Sr, ¹⁷¹Yb, etc. In an example, the optical pumping process may comprise a Raman transition from a |1>state or a |0>state (similarly, from a |+>state to a |−>state) to a virtual state. For example, the optical pumping process may comprise a transition from a nuclear spin state in the ¹S₀ manifold to a virtual state below the ³P₁ or ³P₀ manifold. Optical pumping may serve to reset the qubit into a |1>state or a |0>state (similarly, from a |+>state to a |−>state).

Operation 420 of a method 400 may comprise applying a modified Control-Z gate between atom A and atom B based on the Rydberg interaction. In some cases, at 410, rather than exciting just the |1>state of atom A to the Rydberg level, both qubit states of atom A may be excited to the Rydberg level. Thus, qubit B may acquire a phase conditioned on the presence of atom A and not the specific state of qubit A.

Operation 430 of a method 400 may comprise rotating qubit B back to the computational basis and performing a measurement. One result indicates that atom A is present, the other result indicates that atom A is lost.

In some cases, a measurement operation herein is a state selective measurement operation. Example measurement operations are described herein with respect to the section “Measurement Operation.”

Operation 440 of a method 400 may comprise determining whether atom A is present based at least in part on the measurement.

Optical pumping—Systems and methods of the present disclosure may use state preparation or resetting techniques in order to set or reset an initial state of a qubit. A qubit state of the present disclosure may be set by optical pumping. Optical pumping may be affected by an optical pumping unit. The optical pumping units may be configured to emit light to optically pump the atoms from an equilibrium distribution of atomic states to a non-equilibrium atomic state. For instance, the optical pumping units may be configured to emit light to optically pump the atoms from an equilibrium distribution of atomic states to a single pure atomic state. The optical pumping units may be configured to emit light to optically pump the atoms to a ground atomic state or to any other atomic state. The optical pumping units may be configured to optically pump the atoms between any two atomic states.

The optical pumping units may comprise one or more light sources (such as any light source described herein) configured to emit light. The light may comprise one or more wavelengths of at least about 400 nm, 410 nm, 420 nm, 430 nm, 440 nm, 450 nm, 460 nm, 470 nm, 480 nm, 490 nm, 500 nm, 510 nm, 520 nm, 530 nm, 540 nm, 550 nm, 560 nm, 570 nm, 580 nm, 590 nm, 600 nm, 610 nm, 620 nm, 630 nm, 640 nm, 650 nm, 660 nm, 670 nm, 680 nm, 690 nm, 700 nm, 710 nm, 720 nm, 730 nm, 740 nm, 750 nm, 760 nm, 770 nm, 780 nm, 790 nm, 800 nm, 810 nm, 820 nm, 830 nm, 840 nm, 850 nm, 860 nm, 870 nm, 880 nm, 890 nm, 900 nm, 910 nm, 920 nm, 930 nm, 940 nm, 950 nm, 960 nm, 970 nm, 980 nm, 990 nm, 1,000 nm, or more. The light may comprise one or more wavelengths of at most about 1,000 nm. 990 nm, 980 nm, 970 nm, 960 nm, 950 nm, 940 nm, 930 nm, 920 nm, 910 nm, 900 nm, 890 nm, 880 nm, 870 nm, 860 nm, 850 nm, 840 nm, 830 nm, 820 nm, 810 nm, 800 nm, 790 nm, 780 nm, 770 nm, 760 nm, 750 nm, 740 nm, 730 nm, 720 nm, 710 nm, 700 nm, 690 nm, 680 nm, 670 nm, 660 nm, 650 nm, 640 nm, 630 nm, 620 nm, 610 nm, 600 nm, 590 nm, 580 nm, 570 nm, 560 nm, 550 nm, 540 nm, 530 nm, 520 nm, 510 nm, 500 nm, 490 nm, 480 nm, 470 nm, 460 nm, 450 nm, 440 nm, 430 nm, 420 nm, 410 nm, 400 nm, or less. The light may comprise one or more wavelengths that are within a range defined by any two of the preceding values. For instance, the light may comprise one or more wavelengths that are within a range from 400 nm to 1,000 nm, 500 nm to 1,000 nm, 600 nm to 1,000 nm, 650 nm to 1,000 nm, 400 nm to 900 nm, 400 nm to 800 nm, 400 nm to 700 nm, 400 nm to 600 nm, 400 nm to 500 nm, 500 nm to 700 nm, or 650 nm to 700 nm.

For example, the optical pumping process may comprise a transition from a nuclear spin state in the ¹S₀ manifold to a state in the ³P₁ or ³P₀ manifold in ⁸⁷Rb, ⁸⁷Sr, ¹⁷¹Yb, etc., and the light may be tuned to a transition frequency between a nuclear spin state in the ¹S₀ manifold to a state in the ³P₁ or ³P₀ manifold in ⁸⁷Rb, ⁸⁷Sr, ¹⁷¹Yb, etc. For example, the optical pumping process may comprise a transition from a nuclear spin state in the ¹S₀ manifold to a virtual state below the ³P₁ or ³P₀, and the light may be tuned to a transition frequency between the nuclear spin state in the ¹S₀ manifold and the virtual state below the ³P₁ or ³P₀ manifold in ⁸⁷Rb, ⁸⁷Sr, ¹⁷¹Yb, etc.

### Qubit Replacement

Methods and systems of the present disclosure may replace qubits into a quantum circuit after a vacancy has been identified. In some cases, the qubit is an atomic qubit. In some cases, the qubit is atom trapped in a spatially distinct optical trapping site. Examples presented herein may be recite qubits comprising neutral atoms; however, the methods and systems herein may be combined with various types of qubits.

In some cases, methods and systems of the present disclosure may replace atoms into an array after a vacancy has been identified. In some cases, individual atoms may be moved from a filled site to an empty site using an optical tweezer. An optical tweezer may be formed from crossed acousto-optical deflectors. In some cases, an array of optical trapping sites may comprise a first array and a second array distinct from the first array. The first array may comprise a science array. The second array may comprise a reservoir array. In some cases, the first array and the second array are physically separated by a distance. In some cases, the first array and the second array are subsets of a single continuous array. To fill a vacancy in an array, an atom replacement operation may comprise moving an atom from a second array to a first array, such as from a reservoir array to a science array. In some cases, once an atom is moved from a second array to a first array, a vacancy is created in the second array. The second array may be refilled from a reservoir optical trap.

An atom replacement operation may be affected by one or more atom movement units. As disclosed here, the systems and methods disclosed herein may use a plurality of arrays of optical traps (e.g., a science array, a reservoir array, an intermediate array, etc.). In some cases, the science array is distinct from the reservoir array. In some cases, the science array is spatially distinct from the reservoir array. For example, the science array may be physically separated from the science array.

Physical separation of the science array and the reservoir array may be useful in at least some respects. For example, if the science array and the reservoir array are physically distinct. the reservoir array can be more easily spatially separated from the science region. This can allow loading into the reservoir array without disturbing atoms in the science region while the reservoir region is being loaded. For example, a disturbance may occur from unwanted scattering, unwanted light shifts, etc. during transfer. In some cases, a separate optical system from the trap excitation may be used to move atoms from a first array to a second array disclosed herein. For example, the reservoir array may be loaded from a separate optical potential or array, which may disturb atoms in the science region if the reservoir and science arrays were too close. Using separate optical systems to generate the two arrays may be helpful for separating the science array and the reservoir array arrays. Using a separate (e.g., a third) optical system, for atom movement may further insulate the arrays.

In some examples, present techniques may be combined with methods for probabilistic, deterministic, or near-deterministic loading of optical or other traps, such as those disclosed herein. In some examples, atoms within the science region may or may not be rearranged as the science array is replenished. In some examples, atoms can be transferred between sites by optical tweezers. In some examples, atoms can be transferred between sites by optical lattices. In some examples, atoms can be transferred between sites by tunneling/hopping between sites. In some examples, atoms can be transferred between sites by autonomous stabilization techniques.

In some cases, atom replacement is performed using one or both of a moving optical trap or an optical tweezer. In some cases, an optical tweezer may be used to move a single atom (e.g., pick and place) or a subset of atoms between arrays or within an array. In some cases, a moving optical trap can be used to translate or compress an array. A moving optical trap may implement a tone to sweep atoms from one location to another. The atom movement units may be configured to move the one or more replacement atoms from the one or more atoms reservoirs to the one or more optical trapping sites. For instance, the one or more atom movement units may comprise one or more electrically tunable lenses, acousto-optic deflectors (AODs), or spatial light modulators (SLMs).

The optical trapping system(s) disclosed herein may comprise one or more atom rearrangement units configured to impart an altered spatial arrangement of the plurality of atoms trapped with the optical trapping sites based on the one or more images obtained by the imaging unit. The optical trapping unit may comprise any number of atom rearrangement units, such as at least about 1, 2, 3, 4, 5, 6, 7, 8, 9, 10, or more atom rearrangement units or at most about 10, 9, 8, 7, 6, 5, 4, 3, 2, or 1 atom rearrangement units. In some cases, the science array is associated with a first spatial light modulator and the reservoir array is associated with a second spatial light modulator.

The atom rearrangement unit may be configured to alter the spatial arrangement in order to obtain an increase in a filling factor of the plurality of optical trapping sites. A filling factor may be defined as a ratio of the number of computationally active optical trapping sites occupied by one or more atoms to the total number of computationally active optical trapping sites available in the optical trapping unit or in a portion of the optical trapping unit. For instance, initial loading of atoms within the computationally active optical trapping sites may give rise to a filling factor of less than 100%, 90%, 80%, 70%, 60%, 50%, or less, such that atoms occupy fewer than 100%, 90%, 70%, 60%, 50%, or less of the available computationally active optical trapping sites, respectively. It may be desirable to rearrange the atoms to achieve a filling factor of at least about 50%, 60%, 70%, 80%, 90%, or 100%. By analyzing the imaging information obtained by the imaging unit, the atom rearrangement unit may attain a filling factor of at least about 50%, 60%, 70%, 80%, 90%, 91%, 92%, 93%, 94%, 95%, 96%, 97%, 98%, 99%, 99.1%, 99.2%, 99.3%, 99.4%, 99.5%, 99.6%, 99.7%, 99.8%, 99.9%, 99.91%, 99.92%, 99.93%, 99.94%, 99.95%, 99.96%, 99.97%, 99.98%, 99.99%, or more. The atom rearrangement unit may attain a filling factor of at most about 99.99%, 99.98%, 99.97%, 99.96%, 99.95%, 99.94%, 99.93%, 99.92%, 99.91%, 99.9%, 99.8%, 99.7%, 99.6%, 99.5%, 99.4%, 99.3%, 99.2%, 99.1%, 99%, 98%, 97%, 96%, 95%, 94%, 93%, 92%, 91%, 90%, 80%, 70%, 60%, 50%, or less. The atom rearrangement unit may attain a filling factor that is within a range defined by any two of the preceding values.

### Modifying the Decoding Algorithm

Systems and methods of the present disclosure may be used in connection with error correction methodologies for quantum computing systems. An error correcting scheme (e.g., an implementation of an error correcting code) of the present disclosure may comprise a decoder and an error correcting code. A decoder may decode which errors occurred on which qubits. Once identified, these errors can be tracked and the information used to correct any subsequent measurement outcomes using the classical control software. The methods of updating the decoder described herein may not depend on the type of atom, the type of qubit, the type of error correction code, or the specific decoder used in the error correcting code. In some cases, an error correcting code may be of the class of stabilizer codes. If the two qubit-gate operation affects the Identity or a Pauli operation, then the matching graph passed to the decoder may be updated as described herein.

Systems and methods of the present disclosure may be used with various error correcting codes. An error correcting code may be a Shor style code. For example, in a Shor style code, repeated rounds of syndrome extraction may be implemented to overcome readout error and build confidence about the state of the system. The extracted syndrome information is then passed to a decoder to determine which errors have occurred and which corrections need to be applied.

Systems and methods of the present disclosure may be used with various stabilizer codes. A stabilizer code may be an error correcting code which uses stabilizers. A stabilizer code may be a class of error correcting code. The class of stabilizer codes may include toric codes, surface codes, etc. By repeatedly measuring a quantum system using a complete set of commuting stabilizers, the system may be forced into a simultaneous and unique eigenstate of all the stabilizers. One can measure the stabilizers without perturbing the system; when the measurement outcomes change, this corresponds to one or more qubit errors, and the quantum state is projected by the measurements onto a different stabilizer eigenstate.

An error correcting code may comprise a topological code. The class of topological codes may overlap with the class of stabilizer codes. A topological code may comprise a surface code, a color code, a toric code, etc. A topological code may also be referred to as a homological code. A topological code may comprise an array or lattice of qubits arranged on a surface (or higher dimensional structure). Systems and methods of the present disclosure may not generally change the underlying topology of a topological code.

Systems and methods disclosed herein may be used with various surface codes. A surface code may be implemented as a stabilizer code. For example, in the surface code literature, surface codes may comprise two types of qubits data qubits and measurement qubits (e.g., ancilla qubits). The data qubits may contain the information carried by the quantum circuit, whose error is to be corrected. The measurement qubits may be used to stabilize and manipulate the quantum state of the data qubit. In a surface code, the measurement qubits may comprise two types: measure-Z qubits and measure-X qubits. These two types of qubits may be called Z syndrome qubits and X-syndrome qubits respectively. The measure Z-qubits may measure the Z stabilizer. The measure X-qubits may measure the X stabilizer. In some cases, a surface code may be implemented with a decoder. In some cases, a surface code can address errors that occur during a surface code cycle as long as the errors that occur during each surface code cycle can be identified.

Systems and methods disclosed herein may employ surface codes. Surface codes disclosed herein may include, for example, variations upon the minimum-weight perfect matching algorithm to decode the surface code. However, many surface codes may be applicable to the systems and methods disclosed herein. A general description of surface codes is provided for example at Fowler, A. G., et al., Surface codes: Towards Practical Large-scale Quantum Computation, arXiv: 1208.0928 [quant-ph] 4 Aug. 2012, available at https://arxiv.org/pdf/1208.0928.pdf, which is incorporated by reference herein in its entirety.

Systems and methods disclosed herein may be used with various color codes. A color code may be implemented as a stabilizer code. For example, a color code may comprise a Steane code, etc. Systems and methods disclosed herein may be used with various Shor style codes, for example, a Bacon-shor code. A Shor style code may be implemented as a stabilizer code. Systems and methods disclosed herein may be used with various qLDPC codes, for example, hypergraph product codes. A qLDPC code may be implemented as a stabilizer code.

Systems and methods disclosed herein may be used with various decoders. An error correcting scheme (e.g., an implementation of an error correcting code) of the present disclosure may comprise a decoder and an error correction code. A decoder may decode which errors occurred on which qubits. Once identified, these errors can be tracked and the information used to correct subsequent measurement outcomes using the classical control software. Decoder algorithms may include, for example, minimum-weight perfect matching, union find, tensor network decoder, belief propagation with ordered statistics decoder, maximum likelihood decoder, and look up table decoders. Methods and systems of the present disclosure may be integrated with variations on the minimum-weight perfect matching such as sparse bloom and fusion blossom. A decoder may take in a matching graph. Systems and method of the present disclosure may update the matching graph passed to the decoder to account for a lost qubit.

In some cases, qubit loss may involve modification to surface code techniques that do not experience qubit loss errors. For example, error correcting code which does not account for qubit loss errors may keep track of a particular qubit changing from 1 to 0 or 0 to 1 unexpectedly. If a qubit has been lost, there is no change in state; instead, there is no value to measure.

Modifying the decoding algorithm may be a sub-operation of an operation for reimplementing the qubit into the circuit. A qubit reimplementing operation may comprise an embodiment, variation, or example of operation 130 of the method 100. In some cases, modifying the decoding algorithm may be performed subsequent to or during a reimplementing operation such as operation 130 of a method 100.

To augment the decoding algorithm, systems and methods disclosed herein may update existing decoders to incorporate the change in error type. In some cases, systems and methods disclosed herein may update the matching graph passed to a decoder. In some cases, systems and methods disclosed herein may update the matching graph passed to a minimum-weight perfect matching decoder algorithm or any other decoder algorithm which takes in a matching graph.

In some examples, to update the matching graph, each node in the graph corresponds to a change-of-value of a particular stabilizer. Certain nodes are connected by edges corresponding to possible physical errors. These edges are weighted based on the likelihood of that particular error occurring. When an atom is lost and then replaced, the loss may be treated like a gate error that occurs with a probability of 50%. The procedure may change slightly if data vs. ancilla qubits are lost.

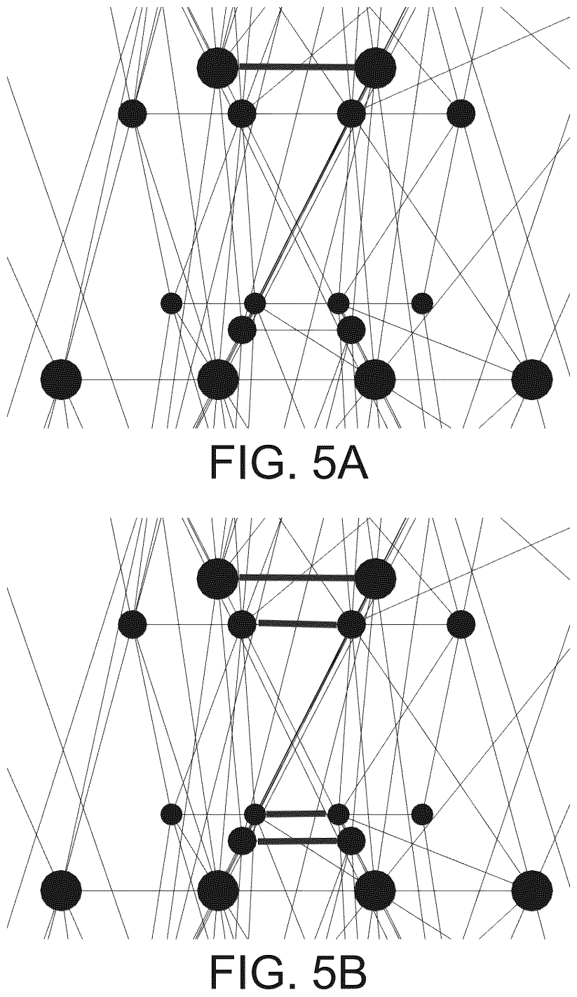

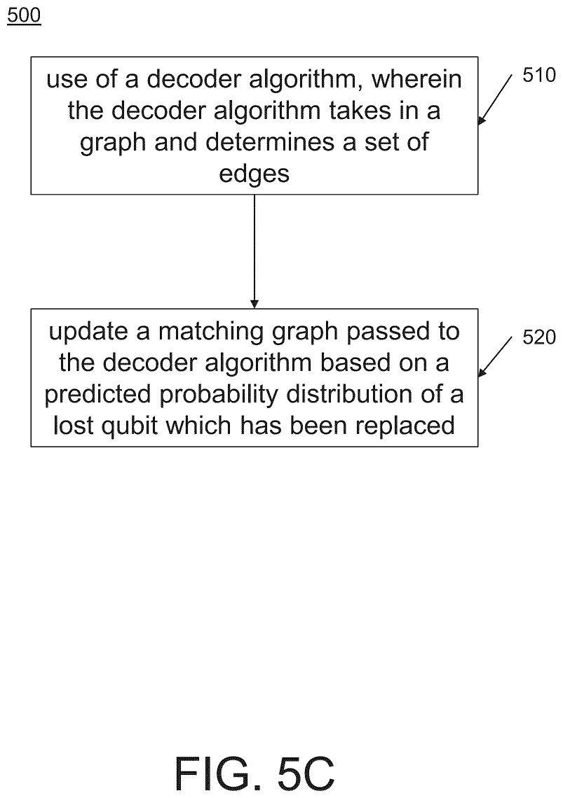

FIG. 5A is a diagram of a matching graph indicating a lost ancilla qubit. Detectors in which the lost qubit participated may be updated. In the graph in the illustrated example, the nodes are detectors and edges connect those nodes. When a lost ancilla is detected, the edge between its corresponding detectors is assigned probability 50%. In the illustrated example, the number of detectors that a lost ancilla is measured by is two. Hook errors are introduced depending on the induced noise. If an ancilla qubit is lost, values for the syndrome data held by the lost ancilla can be chosen and inserted. Then, the matching graph may be updated so that nodes involving that particular syndrome bit are connected by edges corresponding to 50% likelihood of error. In the code, there is a feed forward of probabilities of possible bit flips (both error and not error). The value when the atom with lost is random. Thus, the ancilla qubit loss error from this point may present as a gate error, which may be addressed by various types of surface code.

FIG. 5B is a diagram of a matching graph indicating a lost data qubit. When a lost data qubit is detected, the edges between all appropriate detectors are assigned probability 50%. If a data qubit is lost, all measured syndrome values containing by that data qubit are untrustworthy. In some cases, each data qubit is included in 2, 3, or 4 syndrome measurements. The number of detectors for a particular qubit may vary with a particular type of decoder. Methods and systems described herein may be adapted for any number detectors specified in the decoder so long as each edge between detectors participating with the lost qubit are updated. If a data qubit is lost, all associated syndrome values are untrustworthy. In this case, it may not be needed to insert values for the measured syndrome bits. Instead, the matching graph may be augmented so that all nodes affected by the each of the untrustworthy ancillas are connected by 50% error edges. Thus, the data qubit loss error from this point may present as a gate error, which may be addressed by various types of surface code. In the illustrated example, 4 edges are indicated in bold.

FIG. 5C is a flowchart of a method 500 for reimplementing a qubit. In some cases, modifying the decoding algorithm may be performed subsequent to or during a reimplementing operation such as operation 130 of a method 100.

At an operation 510, the method 500 may comprise use of a decoder algorithm, wherein the decoder algorithm takes in a graph and determines a set of edges. In some cases, the decoder is minimum-weight perfect matching decoder algorithm.

At an operation 520, the method 500 may comprise prior to 510 updating a matching graph passed to the decoder algorithm based on a predicted probability distribution of a lost qubit replaced. The replacement operation may be for example operation 120 of a method 100. In some cases, the matching graph is passed to a minimum-weight perfect matching decoder algorithm. The matching graph may be updated based on a predicted probability distribution of a lost qubit replaced. In some cases, the predicted probability distribution may comprise: if an ancilla qubit is lost, updating the matching graph so that a node involving the ancilla qubit is connected by edges corresponding to the predicted probability distribution; and if a data qubit is lost, updating the matching graph by assigning the predicted probability distribution to each node involving the data qubit. In some cases, each node involving the ancilla qubit is updated.

Operation 520 may be generalized to various decoders and error correcting codes. When a data qubit is lost, it will introduce the same number of pairs of vertices as stabilizers which is in involved. Each data qubit may be involved in some number of parity checks depending upon the error correcting code. In the illustrated example in FIG. 5B, the particular lost data qubit participated in four parity checks, which correspond to four ancillas being measured twice, resulting in four random edges.

### Measurement Operation

At an operation 140 of a method 100 of error correction with atom loss, measurements taken while the qubit was missing may be flagged as untrustworthy. In some cases, operation 140 comprises flagging measurement taken during a window of time that includes a time when the qubit was missing as untrustworthy. For example, a window of time may comprise a round of syndrome measurements. It may not be necessary to know exactly which measurements were taken while the atom was lost, only what set of measurements were taken during a window of time that includes a lost atom. A flagging operation may comprise, prior to flagging a measurement, performing a measurement of one more qubits. The measurement may result in an emission of a photon. In some cases, the measurement may be state selective. For example, a measurement may selectively probe either a |0>state or a |1>state. After a round of measurement, it may be possible to know whether a measured atom is lost. In an example, measurement of ancilla atoms during an error correction protocol may indicate whether an ancilla atom is lost. An identification operation in 110 (e.g., swap gates, a knock-knock protocol, etc.) may be performed in order to determine if a qubit is missing within a set of qubits including a data qubit without measurement of the data qubit.

In systems and methods of the present disclosure, the fact of a missing qubit may not be immediately heralded. For example, it may become apparent that qubit is lost after completing a round of syndrome extraction, rather than immediately upon taking a measurement implicating a lost qubit. Once the round of syndrome extraction is complete, it may become apparent that there was a qubit loss, in order to proceed with the calculation in may be beneficial to flag a series of measurements taken during a window of time that includes a time when the qubit was missing. Each of these measurements may be flagged as untrustworthy. In some cases, the series of time which includes the flagged qubit may not be limited to the time in which the qubit is definitively lost. The series of time which includes the flagged qubit may include at least the time with the qubit was lost.

Advantageously, a qubit loss may be identified before measurement of the data qubits (and after a round of syndrome extraction). Since the data qubits have not yet been measured, it may be possible to continue on with a quantum circuit after replacing a lost qubit. The circuit may be adapted to retake or restart portions of the calculation implicating the lost qubit. As a consequence, systems and methods disclosed herein may allow for loss detection between cycles (or possibly less frequently) rather than after every gate.

For example, the error correcting code may be directed to updating the calculation to address for error. In some cases, knowing about the error may be needed in order to implement error correcting code. However, in other cases, the error correcting code may be modified to account for missing data without explicit knowledge that qubit is lost.

Measurement operation—In some cases, performing a measurement may comprise imaging one or more atoms, for example atoms in an array. Imaging may be affected by exciting an atom into a state that emits, for example, a fluorescing state, a state that spontaneously emits, a state undergoes stimulated emission, a phosphorescing state. Scattered photons after imaging may be collected on a camera or a detector.

In some cases, it may be useful to measure a qubit state selectively. For example, a measurement operation that selectively determines whether the state of the qubit is state |0> or state |1>. It may be useful to measure a qubit state site selectively. For example, a measurement operation that selectively determines a state of a particular qubit in an array may be useful for a quantum computation. It may be useful to measure a qubit without causing atom loss of the qubit from the array. Additionally, because error correcting codes may involve measurements on qubits during an error correcting cycle, measurements which preserve the atom in the array may be helpful for improving the efficiency of error correcting codes.

A measurement operation may employ narrow line-width imaging in combination with a differential Zeeman shift (e.g., a shift in the presence of a magnetic field). Either or both of the qubit states (e.g., |0>, |1>) may be separately imaged by light from an imaging beam. Either or both states may be shifted by an applied magnetic field. The applied magnetic field may determine a selectivity of the imaging transition for either or both qubit states. For example, a strength of the applied magnetic field may selectively move an upper state of the imaging transition, a lower state of the imaging transition or both. In some cases, the applied electric field may be a low magnetic field, e.g., about 500 Gauss magnetic field.

In some cases, performing a measurement operation comprises exposing a qubit to electromagnetic energy, wherein the electromagnetic energy is configured to selectively drive a qubit from an initial state to an excited state in a presence of an applied magnetic field. In some cases, a selectivity of a transition to the excited state is based at least in part on a strength of the applied magnetic field. In some cases, determining a state of qubit is based at least in part on the qubit returning to the initial state by emission of a photon in response to the electromagnetic energy.

Mid Circuit Measurement—The methods and systems described herein may be allow for identification of a lost qubit substantially without stopping the circuit. For example, if a set of measurements are flagged as untrustworthy, the circuit may continue with other measurements and return to retake the measurements that were untrustworthy. For example, if a data qubit is flagged as missing, the circuit may continue on other qubits while the atom is replaced and a portion of a circuit comprising that qubit may be reimplemented.

The methods and systems described herein may allow for identification of a lost qubit and replacement of the lost qubit without measurement of each or a plurality of data qubits. As noted above, a missing qubit may be identified in a round of syndrome measurements without measurement of the data qubit. Accordingly, an atom identified as missing may be replaced and a circuit may be continued without measurement of a data qubit.

The methods and systems described herein may be allow for identification of a lost qubit without loss of coherence of each or a plurality of data qubits. As noted, because the error correcting code uses measurements of syndrome qubits to identify atom loss, a data qubit may not need to be measured during around error correction. Systems and methods of the present disclosure may allow for continuous correction of atom loss. Systems and methods of the present disclosure may allow for correction of atom loss mid-circuit.

### Decoder Updating in Neutral Atom Quantum Computation

Qubits—In some cases, the qubit described herein are neutral atom qubits. In some cases, the neutral atoms comprise a Group II element. In some cases, the Group II element is strontium. In some cases, the neutral atoms comprise rubidium or cesium. In some cases, the neutral atoms comprise ytterbium. For example, the first plurality of qubits or the second plurality of qubits can include neutral atoms. The one or more atoms can include atoms that are not ionized (e.g., are in a neutral state). In some cases, each atom of the one or more atoms may be a neutral atom. For example, each atom of an array of atoms can be not ionized. In some cases, the one or more atoms may comprise rare earth atoms (e.g., lanthanide series atoms (e.g., ytterbium, neodymium, lanthanum, erbium, etc.), alkali atoms (e.g., sodium, potassium, rubidium, cesium, etc.), alkali earth atoms (e.g., calcium, strontium (e.g., strontium-87 atoms), etc.), or the like, or any combination thereof.

In some cases, the qubits described herein may comprise nuclear spin qubits. The qubit states (e.g., |0>, |1>) may comprise nuclear spin states within an electronic state manifold. For example, the qubit states may be nuclear spin states on a ground state manifold. In some cases, the qubit states may comprise nuclear spin states on a ground state manifold of a Group II or a Group II like element. A Group II like element may comprise two valence electrons. In some cases, the ground state manifold is a ¹S₀ state. In some cases, the ground state manifold is a ¹S₀ state of ⁸⁷Rb, ⁸⁷Sr, ¹⁷¹Yb, etc.

Qubit States—In some cases, the qubits described herein may comprise a first atomic state and a second atomic state. The first atomic state may comprise a first single-qubit state. The second atomic state may comprise a second single-qubit state. The first atomic state or second atomic state may be elevated in energy with respect to a ground atomic state of the atoms, e.g., within an excited state manifold. The first atomic state or second atomic state may be within a ground state manifold.

The first atomic state may comprise a first hyperfine electronic state and the second atomic state may comprise a second hyperfine electronic state that is different from the first hyperfine electronic state. For instance, the first and second atomic states may comprise first and second hyperfine states on a multiplet manifold, such as a triplet manifold, a singlet manifold, etc. The first and second atomic states may comprise first and second hyperfine states, respectively, on a ³P₁, ³P₂, ¹S₀ manifold, etc. The first and second atomic states may comprise first and second hyperfine states, respectively, on a ³P₁, ³P₂, ¹S₀ manifold of any atom described herein, such as a strontium-87 ³P₁ manifold, a strontium-87 ³P₂, a strontium-87 ¹S₀, ytterbium-171 ³P₁ manifold, a ytterbium-171 ³P₂, a ytterbium-171 ¹S₀ manifold.

In some cases, the first and second atomic states are first and second hyperfine states of a first electronic state. Optical excitation may be applied between a first electronic state and a second electronic state. The optical excitation may excite the first hyperfine state and/or the second hyperfine state to the second electronic state. A single-qubit transition may comprise a two-photon transition between two hyperfine states within the first electronic state using a second electronic state as an intermediate state. To drive a single-qubit transition, a pair of frequencies, each detuned from a single-photon transition to the intermediate state, may be applied to drive a two-photon transition. In some cases, the first and second hyperfine states are hyperfine states of the ground electronic state. The ground electronic state may not decay by spontaneous or stimulated emission to a lower electronic state. The hyperfine states may comprise nuclear spin states.

In some cases, the hyperfine states comprise nuclear spin states of a strontium-87 ¹S₀ or a ytterbium-171 ¹S₀ manifold and the qubit transition drives one or both of two nuclear spin states of strontium-87 ¹S₀ or a ytterbium-171 ¹S₀ to a state detuned from or within the ³P₂ or ³P₁ manifold. In some cases, the one-qubit transition is a two photon Raman transition between nuclear spin states of strontium-87 ¹S₀ or ytterbium-171 ¹S₀ via a state detuned from or within the ³P₂ or ³P₁ manifold. In some cases, the nuclear spin states may be Stark shifted nuclear spin states. A Stark shift may be driven optically. An optical Stark shift may be driven off resonance with any, all, or a combination of a single-qubit transition, a two-qubit transition, a shelving transition, an imaging transition, etc.

In some cases, the hyperfine states comprise nuclear spin states of ytterbium.

The first atomic state may comprise a first nuclear spin state and the second atomic state may comprise a second nuclear spin state that is different from the first nuclear spin state. The first and second atomic states may comprise first and second nuclear spin states, respectively, of a quadrupolar nucleus. The first and second atomic states may comprise first and second nuclear spin states, respectively, of a spin-1, spin-3/2, spin-2, spin-5/2, spin-3, spin-7/2, spin-4, or spin-9/2 nucleus. The first and second atomic states may comprise first and second nuclear spin states, respectively, of any atom described herein, such as first and second spin states of strontium-87.

For first and second nuclear spin states associated with a nucleus comprising a spin greater than 1/2 (such as a spin-1, spin-3/2, spin-2, spin-5/2, spin-3, spin-7/2, spin-4, or spin-9/2 nucleus), transitions between the first and second nuclear spin states may be accompanied by transitions between other spin states on the nuclear spin manifold. For instance, for a spin-9/2 nucleus in the presence of a uniform magnetic field, all of the nuclear spin levels may be separated by equal energy. Thus, a transition (such as a Raman transition) designed to transfer atoms from, for instance, an m_{N}=9/2 spin state to an m_{N}=7/2 spin state, may also drive m_{N}=7/2 to m_{N}=5/2, m_{N}=5/2 to m_{N}=3/2, m_{N}=3/2 to m_{N}=1/2, m_{N}=1/2 to m_{N}=−1/2, m_{N}=−1/2 to m_{N}=−3/2, m_{N}=−3/2 to m_{N}=−5/2, m_{N}=−5/2 to m_{N}=−7/2, and m_{N}=−7/2 to m_{N}=−9/2, where m_{N} is the nuclear spin state. Similarly, a transition (such as a Raman transition) designed to transfer atoms from, for instance, an m_{N}=9/2 spin state to an m_{N}=5/2 spin state, may also drive m_{N}=7/2 to m_{N}=3/2, m_{N}=5/2 to m_{N}=1/2, m_{N}=3/2 to m_{N}=−1/2, m_{N}=1/2 to m_{N}=−3/2, m_{N}=−1/2 to m_{N}=−5/2, m_{N}=−3/2 to m_{N}=−7/2, and m_{N}=−5/2 to m_{N}=−9/2. Such a transition may thus not be selective for inducing transitions between particular spin states on the nuclear spin manifold.

It may be desirable to instead implement selective transitions between particular first and second spins states on the nuclear spin manifold. This may be accomplished by providing light from a light source that provides an AC Stark shift and pushes neighboring nuclear spin states out of resonance with a transition between the desired transition between the first and second nuclear spin states. For instance, if a transition from first and second nuclear spin states having m_{N}=−9/2 and m_{N}=−7/2 is desired, the light may provide an AC Stark shift to the m_{N}=−5/2 spin state, thereby greatly reducing transitions between the m_{N}=−7/2 and m_{N}=−5/2 states. Similarly, if a transition from first and second nuclear spin states having m_{N}=−9/2 and m_{N}=−5/2 is desired, the light may provide an AC Stark shift to the m_{N}=−1/2 spin state, thereby greatly reducing transitions between the m_{N}=−5/2 and m_{N}=−1/2 states. This may effectively create a two-level subsystem within the nuclear spin manifold that is decoupled from the remainder of the nuclear spin manifold, greatly simplifying the dynamics of the qubit systems. It may be advantageous to use nuclear spin states near the edge of the nuclear spin manifold (e.g., m_{N}=9/2 and m_{N}=−7/2, m_{N}=7/2 and m_{N}=9/2, m_{N}=−9/2 and m_{N}=−5/2, or m_{N}=5/2 and m_{N}=9/2 for a spin-9/2 nucleus) such that only one AC Stark shift is required. Alternatively, nuclear spin states farther from the edge of the nuclear spin manifold (e.g., m_{N}=−5/2 and m_{N}=−3/2 or m_{N}=−5/2 and m_{N}=−1/2) may be used and two AC Stark shifts may be implemented (e.g., at m_{N}=−7/2 and m_{N}=−1/2 or m_{N}=−9/2 and m_{N}=3/2).

Stark shifting of the nuclear spin manifold may shift neighboring nuclear spin states out of resonance with the desired transition between the first and second nuclear spin states and a second electronic state or a state detuned therefrom. Stark shifting may decrease leakage from the first and second nuclear spin state to other states in the nuclear spin manifold. Starks shifts may be achievable up to 100s of kHz for less than 10 mW beam powers. Upper state frequency selectivity may decrease scattering from imperfect polarization control. Separation of different angular momentum states in the ³P₁ manifold may be many gigahertz from the single and two-qubit gate light. Leakage to other states in the nuclear spin manifold may lead to decoherence. The Rabi frequency for two-qubit transitions (e.g., how quickly the transition can be driven) may be faster than the decoherence rate. Scattering from the intermediate state in the two-qubit transition may be a source of decoherence. Detuning from the intermediate state may improve fidelity of two-qubit transitions.

Qubits based on nuclear spin states in the electronic ground state may allow exploitation of long-lived metastable excited electronic states (such as a ³P₀ state in strontium-87 or ytterbium-171) for qubit storage. Atoms may be selectively transferred into such a state to reduce crosstalk or to improve gate or detection fidelity. Such a storage or shelving process may be atom-selective using the SLMs or AODs described herein. A shelving transition may comprise a transition between the ¹S₀ state in strontium-87 or ytterbium-171 to the ³P₀ or ³P₂ state in strontium-87 or a ytterbium-171.

The clock transition (also a “shelving transition” or a “storage transition” herein) may be qubit-state selective. The upper state of the clock transition may have a very long natural lifetime, e.g., greater than 1 second. The linewidth of the clock transition may be much narrower than the qubit energy spacing. This may allow direct spectral resolution. Population may be transferred from one of the qubit states into the clock state. This may allow individual qubit states to be read out separately, by first transferring population from one qubit state into the clock state, performing imaging on the qubits, then transferring the population back into the ground state from the clock state and imaging again. In some cases, a magic wavelength transition is used to drive the clock transition.

The clock light for shelving can be atom-selective or not atom-selective. In some cases, the clock transition is globally applied (e.g., not atom selective). A globally applied clock transition may include directing the light without passing through a microscope objective or structuring the light. In some cases, the clock transition is atom-selective. Clock transition which are atom-selective may potentially allow us to improve gate fidelities by minimizing crosstalk. For example, to reduce cross talk in an atom, the atom may be shelved in the clock state where it may not be effected by the light. This may reduce crosstalk between neighboring qubits undergoing transitions. To implement atom-selective clock transitions, the light may pass through one or more microscope objectives and/or may be structured on one or more of a spatial light modulator, digital micromirror device, crossed acousto-optic deflectors, etc.

Multi-qubit gates—Two-qubit gates and multi-qubit gates may be enabled by entanglement units herein. For example, an entanglement excitation may be configured to implement an entanglement operation between a first qubit and another qubit distinct from the first qubit. The entanglement units may be configured to quantum mechanically entangle at least a first atom of the plurality of atoms with at least a second atom of the plurality of atoms. The first or second atom may be in a superposition state at the time of quantum mechanical entanglement. Alternatively or in addition, the first or second atom may not be in a superposition state at the time of quantum mechanical entanglement. The first atom and the second atom may be quantum mechanically entangled through one or more magnetic dipole interactions, induced magnetic dipole interactions, electric dipole interactions, or induced electric dipole interactions. The entanglement units may be configured to quantum mechanically entangle any number of atoms described herein.

The entanglement units may also be configured to quantum mechanically entangle at least a subset of the atoms with at least another atom to form one or more multi-qubit units. The multi-qubit units may comprise two-qubit units, three-qubit units, four-qubit units, or n-qubit units, where n may be 5, 6, 7, 8, 9, 10, or more. For instance, a two-qubit unit may comprise a first atom quantum mechanically entangled with a second atom, a three-qubit unit may comprise a first atom quantum mechanically entangled with a second and third atom, a four-qubit unit may comprise a first atom quantum mechanically entangled with a second, third, and fourth atom, and so forth. The first, second, third, or fourth atom may be in a superposition state at the time of quantum mechanical entanglement. Alternatively or in addition, the first, second, third, or fourth atom may not be in a superposition state at the time of quantum mechanical entanglement. The first, second, third, and fourth atom may be quantum mechanically entangled through one or more magnetic dipole interactions, induced magnetic dipole interactions, electric dipole interactions, or induced electric dipole interactions.

The entanglement units may comprise one or more Rydberg units. The Rydberg units may be configured to electronically excite the at least first atom to a Rydberg state or to a superposition of a Rydberg state and a lower-energy atomic state, thereby forming one or more Rydberg atoms or dressed Rydberg atoms. The Rydberg units may be configured to induce one or more quantum mechanical entanglements between the Rydberg atoms or dressed Rydberg atoms and the at least second atom. The second atom may be located at a distance of at least about 200 nanometers (nm), 300 nm, 400 nm, 500 nm, 600 nm, 700 nm, 800 nm, 900 nm, 1 micrometer (μm), 2 μm, 3 μm, 4 μm, 5 μm, 6 μm, 7 μm, 8 μm, 9 μm, 10 μm, or more from the Rydberg atoms or dressed Rydberg atoms. The second atom may be located at a distance of at most about 10 μm, 9 μm, 8 μm, 7 μm, 6 μm, 5 μm, 4 μm, 3 μm, 2 μm, 1 μm, 900 nm, 800 nm, 700 nm, 600 nm, 500 nm, 400 nm, 300 nm, 200 nm, or less from the Rydberg atoms or dressed Rydberg atoms. The second atom may be located at a distance from the Rydberg atoms or dressed Rydberg atoms that is within a range defined by any two of the preceding values. The Rydberg units may be configured to allow the Rydberg atoms or dressed Rydberg atoms to relax to a lower-energy atomic state, thereby forming one or more two-qubit units. The Rydberg units may be configured to induce the Rydberg atoms or dressed Rydberg atoms to relax to a lower-energy atomic state. The Rydberg units may be configured to drive the Rydberg atoms or dressed Rydberg atoms to a lower-energy atomic state. For instance, the Rydberg units may be configured to apply electromagnetic radiation (such as RF radiation or optical radiation) to drive the Rydberg atoms or dressed Rydberg atoms to a lower-energy atomic state. The Rydberg units may be configured to induce any number of quantum mechanical entanglements between any number of atoms of the plurality of atoms.

The Rydberg units may comprise one or more light sources (such as any light source described herein) configured to emit light having one or more ultraviolet (UV) wavelengths. The UV wavelengths may be selected to correspond to a wavelength that forms the Rydberg atoms or dressed Rydberg atoms. For instance, the light may comprise one or more wavelengths of at least about 200 nm, 210 nm, 220 nm, 230 nm, 240 nm, 250 nm, 260 nm, 270 nm, 280 nm, 290 nm, 300 nm, 310 nm, 320 nm, 330 nm, 340 nm, 350 nm, 360 nm, 370 nm, 380 nm, 390 nm, 400 nm, or more. The light may comprise one or more wavelengths of at most about 400 nm, 390 nm, 380 nm, 370 nm, 360 nm, 350 nm, 340 nm, 330 nm, 320 nm, 310 nm, 300 nm, 290 nm, 280 nm, 270 nm, 260 nm, 250 nm, 240 nm, 230 nm, 220 nm, 210 nm, 200 nm, or less. The light may comprise one or more wavelengths that are within a range defined by any two of the preceding values. For instance, the light may comprise one or more wavelengths that are within a range from 300 nm to 400 nm.

The Rydberg units may be configured to induce a two-photon transition to generate an entanglement. The Rydberg units may be configured to induce a two-photon transition to generate an entanglement between two atoms. The Rydberg units may be configured to selectively induce a two-photon transition to selectively generate an entanglement between two atoms. For instance, the Rydberg units may be configured to direct electromagnetic energy (such as optical energy) to particular optical trapping sites to selectively induce a two-photon transition to selectively generate the entanglement between the two atoms. The two atoms may be trapped in nearby optical trapping sites. For instance, the two atoms may be trapped in adjacent optical trapping sites. The two-photon transition may be induced using first and second light from first and second light sources, respectively. The first and second light sources may each comprise any light source described herein (such as any laser described herein). The first light source may be the same or similar to a light source used to perform a single-qubit operation described herein. Alternatively, different light sources may be used to perform a single-qubit operation and to induce a two-photon transition to generate an entanglement. The first light source may emit light comprising one or more wavelengths in the visible region of the optical spectrum (e.g., within a range from 400 nm to 800 nm or from 650 nm to 700 nm). The second light source may emit light comprising one or more wavelengths in the ultraviolet region of the optical spectrum (e.g., within a range from 200 nm to 400 nm or from 300 nm to 350 nm). The first and second light sources may emit light having substantially equal and opposite spatially-dependent frequency shifts.

The Rydberg atoms or dressed Rydberg atoms may comprise a Rydberg state that may have sufficiently strong interatomic interactions with nearby atoms (such as nearby atoms trapped in nearby optical trapping sites) to enable the implementation of multi-qubit operations. The Rydberg states may comprise a principal quantum number of at least about 50, 60, 70, 80, 90, 100, or more. The Rydberg states may comprise a principal quantum number of at most about 100, 90, 80, 70, 60, 50, or less. The Rydberg states may comprise a principal quantum number that is within a range defined by any two of the preceding values. The Rydberg states may interact with nearby atoms through van der Waals interactions. The van der Waals interactions may shift atomic energy levels of the atoms.

State selective excitation of atoms to Rydberg levels may enable the implementation of multi-qubit operations. The multi-qubit operations may comprise two-qubit operations, three-qubit operations, or n-qubit operations, where n is 4, 5, 6, 7, 8, 9, 10, or more. Two-photon transitions may be used to excite atoms from a ground state (such as a ¹S₀ ground state) to a Rydberg state (such as an n³S₁ state, wherein n is a principal quantum number described herein). State selectivity may be accomplished by a combination of laser polarization and spectral selectivity. The two-photon transitions may be implemented using first and second laser sources, as described herein. The first laser source may emit pi-polarized light, which may not change the projection of atomic angular momentum along a magnetic field. The second laser may emit circularly polarized light, which may change the projection of atomic angular momentum along the magnetic field by one unit. The first and second qubit levels may be excited to Rydberg level using this polarization. However, the Rydberg levels may be more sensitive to magnetic fields than the ground state so that large splittings (for instance, on the order of 100s of MHz) may be readily obtained. This spectral selectivity may allow state selective excitation to Rydberg levels.

Multi-qubit operations (such as two-qubit operations, three-qubit operations, four-qubit operations, and so forth) may rely on energy shifts of levels due to van der Waals interactions described herein. Such shifts may either prevent the excitation of one atom conditional on the state of the other or change the coherent dynamics of excitation of the two-atom system to enact a two-qubit operation. In some cases, “dressed states” may be generated under continuous driving to enact two-qubit operations without requiring full excitation to a Rydberg level (for instance, as described in www.arxiv.org/abs/1605.05207, which is incorporated herein by reference in its entirety for all purposes).

One qubit gates, two qubit gates, and multi qubit gates may be implemented by one or more non-classical computation units. The non-classical computation units may be configured to perform one-qubit gate operations, two-qubit gate operations, multi-qubit gate operations and sequences and combinations thereof to perform a non-classical computation. The non-classical computation units may comprise electromagnetic delivery units. For example, any electromagnetic delivery unit disclosed herein. The electromagnetic delivery units disclosed herein with respect to cooling and trapping may be the same electromagnetic delivery units used for qubit gate operations or different. The electromagnetic energy may comprise one or more pulses, pulse sequences, or optical waveforms. The non-classical computation units may comprise one or more entanglement units disclosed herein, one or more Rydberg units disclosed herein, or both. In some cases, a Rydberg unit disclosed herein is an example of an entanglement unit disclosed herein which uses a Rydberg excitation to generate entanglement and to perform two-qubit gate or multi-qubit gate operations.

A non-classical computation may be configured to provide pulses, pulse sequences, or optical waveforms to perform the non-classical computation. The pulses, pulse sequences, or optical waveforms may comprise any number of pulses, pulse sequences, or optical waveforms. For instance, pulses, pulse sequences, or optical waveforms may comprise at least about 1, 2, 3, 4, 5, 6, 7, 8, 9, 10, 20, 30, 40, 50, 60, 70, 80, 90, 100, 200, 300, 400, 500, 600, 700, 800, 900, 1,000, or more pulses or sub-waveforms. The pulses, pulse sequences, or optical waveforms may comprise at most about 1,000, 900, 800, 700, 600, 500, 400, 300, 200, 100, 90, 80, 70, 60, 50, 40, 30, 20, 10, 9, 8, 7, 6, 5, 4, 3, 2, or 1 pulses or sub-waveforms. The pulses, pulse sequences, or optical waveforms may comprise a number of pulses or sub-waveforms that is within a range defined by any two of the preceding values. Each pulse of the pulse sequence may comprise any pulse shape, such as any pulse shape described herein.

The pulses, pulse sequences, or optical waveforms may be configured to decrease the duration of time required to implement multi-qubit operations, as described herein (for instance, with respect to Example 3). For instance, the pulse sequences may comprise a duration of at least about 10 nanoseconds (ns), 20 ns, 30 ns, 40 ns, 50 ns, 60 ns, 70 ns, 80 ns, 90 ns, 100 ns, 200 ns, 300 ns, 400 ns, 500 ns, 600 ns, 700 ns, 800 ns, 900 ns, 1 microsecond (μs), 2 μs, 3 μs, 4 μs, 5 μs, 6 μs, 7 μs, 8 μs, 9 μs, 10 μs, 20 μs, 30 μs, 40 μs, 50 μs, 60 μs, 70 μs, 80 μs, 90 μs, 100 −s, or more. The pulse sequences may comprise a duration of at most about 100 μs, 90 μs, 80 μs, 70μs, 60 μs, 50μs, 40μs, 30 μs, 20 μs, 10 μs, 9 μs, 8 μs, 7 μs, 6 μs, 5 μs, 4 μs, 3 μs, 2 μs, 1 μs, 900 ns, 800 ns, 700 ns, 600 ns, 500 ns, 400 ns, 300 ns, 200 ns, 100 ns, 90 ns, 80 ns, 70 ns, 60 ns, 50 ns, 40 ns, 30 ns, 20 ns, 10 ns, or less. The pulse sequences may comprise a duration that is within a range defined by any two of the preceding values.

The pulses, pulse sequences, or optical waveforms may be configured to increase the fidelity of multi-qubit operations, as described herein. For instance, the pulses, pulse sequences, or optical waveforms may enable multi-qubit operations with a fidelity of at least about 0.5, 0.6, 0.7, 0.8, 0.9, 0.91, 0.92, 0.93, 0.94, 0.95, 0.96, 0.97, 0.98, 0.99, 0.991, 0.992, 0.993, 0.994, 0.995, 0.996, 0.997, 0.998, 0.999, 0.9991, 0.9992, 0.9993, 0.9994, 0.9995, 0.9996, 0.9997, 0.9998, 0,9999, 0.99991, 0.99992, 0.99993, 0.99994, 0.99995, 0.99996, 0.99997, 0.99998, 0.99999, 0.999991, 0.999992, 0.999993, 0.999994, 0.999995, 0.999996, 0.999997, 0.999998, 0.999999, or more. The pulse sequences may enable multi-qubit operations with a fidelity of at most about 0.999999, 0.999998, 0.999997, 0.999996, 0.999995, 0.999994, 0.999993, 0.999992, 0.999991, 0.99999, 0.99998, 0.99997, 0.99996, 0.99995, 0.99994, 0.99993, 0.99992, 0.99991, 0.9999, 0.9998, 0.9997, 0.9996, 0.9995, 0.9994, 0.9993, 0.9992, 0.9991, 0.999, 0.998, 0.997, 0.996, 0.995, 0.994, 0.993, 0.992, 0.991, 0.99, 0.98, 0.97, 0.96, 0.95, 0.94, 0.93, 0.92, 0.91, 0.9, 0.8, 0.7, 0.6, 0.5, or less. The pulse sequences may enable multi-qubit operations with a fidelity that is within a range defined by any two of the preceding values.

The pulses, pulse sequences, or optical waveforms may enable the implementation of multi-qubit operations on non-adiabatic timescales while maintaining effectively adiabatic dynamics. For instance, the pulse sequences may comprise one or more of shortcut to adiabaticity (STA) pulse sequences, transitionless quantum driving (TQD) pulse sequences, superadiabatic pulse sequences, counterdiabatic driving pulse sequences, derivative removal by adiabatic gate (DRAG) pulse sequences, and weak anharmonicity with average Hamiltonian (Wah Wah) pulse sequences. For instance, the pulse sequences may be similar to those described in M. V. Berry, “Transitionless Quantum Driving,”Journal of Physics A: Mathematical and Theoretical 42(36), 365303 (2009), www.doi.org/10.1088/1751-8113/42/36/365303; Y-Y. Jau et al., “Entangling Atomic Spins with a Strong Rydberg-Dressed Interaction,” Nature Physics 12(1), 71-74 (2016); T. Keating et al., “Robust Quantum Logic in Neutral Atoms via Adiabatic Rydberg Dressing,”Physical Review A 91, 012337 (2015); A. Mitra et al., “Robust Mölmer-Sörenson Gate for Neutral Atoms Using Rapid Adiabatic Rydberg Dressing.” www.arxiv.org/abs/1911.04045 (2019); or L. S. Theis et al., “Counteracting Systems of Diabaticities Using DRAG Controls: The Status after 10 Years,” Europhysics Letters 123(6), 60001 (2018), each of which is incorporated herein by reference in its entirety for all purposes.

The pulses, pulse sequences, or optical waveforms may further comprise one or more optimal control pulse sequences. The optimal control pulse sequences may be derived from one or more procedures, including gradient ascent pulse engineering (GRAPE) methods, Krotov's method, chopped basis methods, chopped random basis (CRAB) methods, Nelder-Mead methods, gradient optimization using parametrization (GROUP) methods, genetic algorithm methods, and gradient optimization of analytic controls (GOAT) methods. For instance, the pulse sequences may be similar to those described in N. Khaneja et al., “Optimal Control of Coupled Spin Dynamics: Design of NMR Pulse Sequences by Gradient Ascent Algorithms,” Journal of Magnetic Resonance 172(2), 296-305 (2005); or J. T. Merrill et al., “Progress in Compensating Pulse Sequences for Quantum Computation,” Advances in Chemical Physics 154, 241-294 (2014), each of which is incorporated by reference in its entirety for all purposes.

Spatially distinct optical traps—In the example of a trapped atom quantum computer, any of the methods disclosed herein such as method 100, 200, 300, 400, 500 may comprise an initial operation of providing a plurality of spatially distinct optical traps where the plurality of traps, wherein each trap is configured to trap an atom, and wherein that atom is a qubit.

In some examples, the optical traps may be formed by tightly focused light (tweezers) or by standing-wave lattices, or by imaged masks or gratings. Optical trapping may additionally include various methods where atoms are cooled with optical illumination, e.g., a laser, and a spatially varying magnetic field to create a trap. Such optical traps may be called magneto-optical traps (MOTs).

In some cases, the array is two dimensional. In some cases, the array is three dimensional. In some cases, the plurality of spatially distinct optical traps comprises a 1D, 2D, or 3D optical trap. In some examples, the arrays may be linear, two-dimensional, three-dimensional, or may involve synthetic dimensions. A synthetic dimension may include, for example, dimensions consisting of internal atomic states or motional states. The plurality of spatially distinct optical traps may comprise single or multiple reservoir regions. In some examples, the arrays may be of regular or irregular or quasi-regular geometry.

In some cases, the array is two-dimensional. For example, an array of two-dimensional optical traps can be formed. The two-dimensional array can include a rectangular, square, rectangular prism, or cubic array of optical trapping sites. In some cases, the method further comprises determining, based at least in part on determining that a number of spatially distinct optical trapping sites of the array of spatially distinct optical trapping sites is missing a qubit. For example, each optical trapping site of the plurality of optical trapping sites may be spatially separated from each other optical trapping site by a distance of at least about 200 nm, 300 nm, 400 nm, 500 nm, 600 nm, 700 nm, 800 nm, 900 nm, 1 μm, 2 μm, 3 μm, 4 μm, 5 μm, 6 μm, 7 μm, 8 μm, 9 μm, 10 μm, or more. Each optical trapping site may be spatially separated from each other optical trapping site by a distance of at most about 10 μm, 9 μm, 8 μm, 7 μm, 6 μm, 5 μm, 4 μm, 3 μm, 2 μm, 1 μm, 900 nm, 800 nm, 700 nm, 600 nm, 500 nm, 400 nm, 300 nm, 200 nm, or less. Each optical trapping site may be spatially separated from each other optical trapping site by a distance that is within a range defined by any two of the preceding values. In some cases, the array is three-dimensional. For example, an array of three-dimensional optical traps can be formed.

Cooling—The array of spatially distinct optical trapping sites may comprise a portion of an atom cooling and trapping system. The atom cooling and trapping system may comprise one or a plurality of optical lattices. For example, the atom cooling and trapping system may comprise a first optical lattice followed by a second optical lattice. In some cases, the optical lattices may be filled by a reservoir trap. In some cases, the reservoir may comprise an unstructured or semi-structured optical trap. In some cases, atoms can be loaded from a pre-cooled atomic beam into a two-stage magneto-optical trap (formed using the 399 nm ¹P₁ transition followed by the 556 nm ³P₁ narrow-line transition). In some cases, atoms can then be loaded into an optical lattice formed using 532 nm light from an optical trapping system.

The qubits in the array of spatially distinct traps may be cooled to a temperature. In some cases, the qubits comprise a temperature of at most 10 microkelvin (μk). In some cases, the qubits comprise a temperature of at most 10 microkelvin (μk). In some cases, the one or more atoms disposed within the optical traps can include a temperature of at least about 1, 2, 3, 4, 5, 10, 15, 20, 25, 30, 35, 40, 45, 50, 55, 60, 65, 70, 75, 80, 85, 90, 95, 100, 110, 120, 130, 140, 150, 160, 170, 180, 190, 200, 300, 400, 500, or more microkelvin. In some cases, the one or more atoms disposed within the within the optical traps can include a temperature of at most about 500, 400, 300, 200, 190, 180, 170, 160, 150, 140, 130, 120, 110, 100, 95, 90, 85, 80, 75, 70, 65, 60, 55, 50, 45, 40, 35, 30, 25, 20, 15, 10, 5, 4, 3, 2, 1, or less microkelvin. In some cases, the one or more atoms disposed within the optical traps can include a temperature in a range as defined by any two of the proceeding values.

Optical tweezers—In some cases, the plurality of spatially distinct optical traps comprises optical tweezers. The optical trapping sites may comprise one or more optical tweezers. Optical tweezers may comprise one or more focused laser beams to provide an attractive or repulsive force to hold or move the one or more atoms. The beam waist of the focused laser beams may comprise a strong electric field gradient. The atoms may be attracted or repelled along the electric field gradient to the center of the laser beam, which may contain the strongest electric field. The optical trapping sites may comprise one or more optical tweezer sites of one or more optical arrays of tweezers. The optical trapping sites may comprise one or more optical tweezer sites of one or more one-dimensional (1D) optical arrays of tweezers, two-dimensional (2D) optical arrays of tweezers, or three-dimensional (3D) optical arrays of tweezers. In some cases, the methods and systems described herein may be applied similarly to optical lattices. Optical tweezers may be useful in moving atoms or arrays of atoms.

Sites—The optical trapping system may be configured to generate a plurality of optical trapping sites. The optical trapping system may be configured to generate a plurality of spatially distinct optical trapping sites. Each optical trapping system may comprise any number of sites disclosed herein. Each optical trapping system may comprise any number of trapped atoms disclosed herein.

For instance, each optical trapping system may be configured to generate at least about 10, 20, 30, 40, 50, 60, 70, 80, 90, 100, 200, 300, 400, 500, 600, 700, 800, 900, 1,000, 2,000, 3,000, 4,000, 5,000, 6,000, 7,000, 8,000, 9,000, 10,000, 20,000, 30,000, 40,000, 50,000, 60,000, 70,000, 80,000, 90,000, 100,000, 200,000, 300,000, 400,000, 500,000, 600,000, 700,000, 800,000, 900,000, 1,000,000, or more optical trapping sites. Each optical trapping system may be configured to generate at most about 1,000,000, 900,000, 800,000, 700,000, 600,000, 500,000, 400,000, 300,000, 200,000, 100,000, 90,000, 80,000, 70,000, 60,000, 50,000, 40,000, 30,000, 20,000, 10,000, 9,000, 8,000, 7,000, 6,000, 5,000, 4,000, 3,000, 2,000, 1,000, 900, 800, 700, 600, 500, 400, 300, 200, 100, 90, 80, 70, 60, 50, 40, 30, 20, 10, or fewer optical trapping sites. The optical trapping system(s) may be configured to trap a number of optical trapping sites that is within a range defined by any two of the preceding values.

Each optical trapping system may be configured to trap a plurality of atoms. For instance, each optical trapping system may be configured to trap a total number of atoms in the plurality of optical trapping sites of at least about 10, 20, 30, 40, 50, 60, 70, 80, 90, 100, 200, 300, 400, 500, 600, 700, 800, 900, 1,000, 2,000, 3,000, 4,000, 5,000, 6,000, 7,000, 8,000, 9,000, 10,000, 20,000, 30,000, 40,000, 50,000, 60,000, 70,000, 80,000, 90,000, 100,000, 200,000, 300,000, 400,000, 500,000, 600,000, 700,000, 800,000, 900,000, 1,000,000, or more atoms. For example, the optical trapping system(s) may be configured to trap a total number of atoms in the plurality of optical trapping sites of at most about 1,000,000, 900,000, 800,000, 700,000, 600,000, 500,000, 400,000, 300,000, 200,000, 100,000, 90,000, 80,000, 70,000, 60,000, 50,000, 40,000, 30,000, 20,000, 10,000, 9,000, 8,000, 7,000, 6,000, 5,000, 4,000, 3,000, 2,000, 1,000, 900, 800, 700, 600, 500, 400, 300, 200, 100, 90, 80, 70, 60, 50, 40, 30, 20, 10, or fewer atoms. The optical trapping system(s) may be configured to trap a number of atoms that is within a range defined by any two of the preceding values.

Trap Electromagnetic Energy—In some cases, method and systems disclosed herein may be configured to form a plurality of optical trapping sites using a trap electromagnetic energy (e.g., a “trap excitation” herein). The trap excitation may be generated by a trapping optical source.

The trap excitation may comprise an optical excitation, such as in a magneto-optical trap, an optical tweezer, etc. In some cases, the trap excitation is delivered by one or more optical trapping systems as disclosed herein. In some cases, each optical trapping system comprises its own trap excitation (e.g., trap wavelength, trap power, trap focus, number of spots, etc.). In some cases, a single trap excitation may be split into multiple arrays in order to form a plurality of arrays of traps with similar characteristics.

Atoms—In some cases, the qubits disclosed herein comprise neutral atom qubits. In some cases, the plurality of atoms comprises neutral atoms. In some cases, the plurality of atoms comprises a Group II element. In some cases, the plurality of atoms comprises Strontium. In some cases, the plurality of atoms comprises a Group II-like element. In some cases, the plurality of atoms an atom with two-valence electrons. In some cases, the plurality of atoms comprises Ytterbium. In some cases, the plurality of atoms are qubits.

The optical trapping system may be configured to trap neutral atoms. In some cases, the optical trapping system may trap alkaline earth or an alkaline earth-like atom. In some cases, an alkaline earth-like atom comprises two valence electrons. In some cases, an alkaline earth or an alkaline earth-like atom comprises strontium or ytterbium.

In some cases, one or more atoms may comprise alkali atoms. One or more atoms may comprise lithium (Li) atoms, sodium (Na) atoms, potassium (K) atoms, rubidium (Rb) atoms, or cesium (Cs) atoms. One or more atoms may comprise lithium-6 atoms, lithium-7 atoms, sodium-23 atoms, potassium-39 atoms, potassium-40 atoms, potassium-41 atoms, rubidium-85 atoms, rubidium-87 atoms, or caesium-133 atoms. One or more atoms may comprise alkaline earth atoms. One or more atoms may comprise beryllium (Be) atoms, magnesium (Mg) atoms, calcium (Ca) atoms, strontium (Sr) atoms, or barium (Ba) atoms. One or more atoms may comprise beryllium-9 atoms, magnesium-24 atoms, magnesium-25 atoms, magnesium-26 atoms, calcium-40 atoms, calcium-42 atoms, calcium-43 atoms, calcium-44 atoms, calcium-46 atoms, calcium-48 atoms, strontium-84 atoms, strontium-86 atoms, strontium-87 atoms, strontium-88 atoms, barium-130 atoms, barium-132 atoms, barium-133 atoms, barium-134 atoms, barium-135 atoms, barium-136 atoms, barium-137 atoms, or barium-138 atoms. One or more atoms may comprise rare earth atoms. One or more atoms may comprise Scandium (Sc) atoms, yttrium (Y) atoms, lanthanum (La) atoms, cerium (Ce) atoms, praseodymium (Pr) atoms, neodymium (Nd) atoms, samarium (Sm) atoms, europium (Eu) atoms, gadolinium (Gd) atoms, terbium (Tb) atoms, dysprosium (Dy) atoms, holmium (Ho) atoms, erbium (Er) atoms, thulium (Tm) atoms, ytterbium (Yb) atoms, or lutetium (Lu) atoms. One or more atoms may comprise scandium-45 atoms, yttrium-89 atoms, lanthanum-139 atoms, cerium-136 atoms, cerium-138 atoms, cerium-140 atoms, cerium-142 atoms, praseodymium-141 atoms, neodymium-142 atoms, neodymium-143 atoms, neodymium-145 atoms, neodymium-146 atoms, neodymium-148 atoms, samarium-144 atoms, samarium-149 atoms, samarium-150 atoms, samarium-152 atoms, samarium-154 atoms, europium-151 atoms, europium-153 atoms, gadolinium-154 atoms, gadolinium-155 atoms, gadolinium-156 atoms, gadolinium-157 atoms, gadolinium-158 atoms, gadolinium-160 atoms, terbium-159 atoms, dysprosium-156 atoms, dysprosium-158 atoms, dysprosium-160 atoms, dysprosium-161 atoms, dysprosium-162 atoms, dysprosium-163 atoms, dysprosium-164 atoms, erbium-162 atoms, erbium-164 atoms, erbium-166 atoms, erbium-167 atoms, erbium-168 atoms, erbium-170 atoms, holmium-165 atoms, thulium-169 atoms, ytterbium-168 atoms, ytterbium-170 atoms, ytterbium-171 atoms, ytterbium-172 atoms, ytterbium-173 atoms, ytterbium-174 atoms, ytterbium-176 atoms, lutetium-175 atoms, or lutetium-176 atoms.

In some cases, the plurality of atoms may comprise a single element selected from the group consisting of Li, Na, K, Rb, Cs, Be, Mg, Ca, Sr, and Ba. The plurality of atoms may comprise a mixture of elements selected from the group consisting of Li, Na, K, Rb, Cs, Be, Mg, Ca, Sr, and Ba. The plurality of atoms may comprise a natural isotopic mixture of one or more elements selected from the group consisting of Li, Na, K, Rb, Cs, Be, Mg, Ca, Sr, and Ba. The plurality of atoms may comprise an isotopically enriched mixture of one or more elements selected from the group consisting of Li, Na, K, Rb, Cs, Be, Mg, Ca, Sr, and Ba. The plurality of atoms may comprise a natural isotopic mixture of one or more elements selected from the group consisting of Sc, Y, La, Ce, Pr, Nd, Sm, Eu, Gd, Tb, Dy, Ho, Er, Tm, Yb, and Lu. The plurality of atoms may comprise an isotopically enriched mixture of one or more elements selected from the group consisting of Sc, Y, La, Ce, Pr, Nd, Sm, Eu, Gd, Tb, Dy, Ho, Er, Tm, Yb, and Lu. atoms may comprise rare earth atoms. For instance, the plurality of atoms may comprise lithium-6 atoms, lithium-7 atoms, sodium-23 atoms, potassium-39 atoms, potassium-40 atoms, potassium-41 atoms, rubidium-85 atoms, rubidium-87 atoms, caesium-133 atoms, beryllium-9 atoms, magnesium-24 atoms, magnesium-25 atoms, magnesium-26 atoms, calcium-40 atoms, calcium-42 atoms, calcium-43 atoms, calcium-44 atoms, calcium-46 atoms, calcium-48 atoms, strontium-84 atoms, strontium-86 atoms, strontium-87 atoms, strontium-88 atoms, barium-130 atoms, barium-132 atoms, barium-133 atoms, barium-134 atoms, barium-135 atoms, barium-136 atoms, barium-137 atoms, barium-138 atoms, scandium-45 atoms, yttrium-89 atoms, lanthanum-139 atoms, cerium-136 atoms, cerium-138 atoms, cerium-140 atoms, cerium-142 atoms, praseodymium-141 atoms, neodymium-142 atoms, neodymium-143 atoms, neodymium-145 atoms, neodymium-146 atoms, neodymium-148 atoms, samarium-144 atoms, samarium-149 atoms, samarium-150 atoms, samarium-152 atoms, samarium-154 atoms, europium-151 atoms, europium-153 atoms, gadolinium-154 atoms, gadolinium-155 atoms, gadolinium-156 atoms, gadolinium-157 atoms, gadolinium-158 atoms, gadolinium-160 atoms, terbium-159 atoms, dysprosium-156 atoms, dysprosium-158 atoms, dysprosium-160 atoms, dysprosium-161 atoms, dysprosium-162 atoms, dysprosium-163 atoms, dysprosium-164 atoms, erbium-162 atoms. erbium-164 atoms, erbium-166 atoms, erbium-167 atoms, erbium-168 atoms, erbium-170 atoms, holmium-165 atoms, thulium-169 atoms, ytterbium-168 atoms, ytterbium-170 atoms, ytterbium-171 atoms, ytterbium-172 atoms, ytterbium-173 atoms, ytterbium-174 atoms, ytterbium-176 atoms, lutetium-175 atoms, or lutetium-176 atoms enriched to an isotopic abundance of at least about 50%, 60%, 70%, 80%, 90%, 91%, 92%, 93%, 94%, 95%, 96%, 97%, 98%, 99%, 99.1%, 99.2%, 99.3%, 99.4%, 99.5%, 99.6%, 99.7%, 99.8%, 99.9%, 99.91%, 99.92%, 99.93%, 99.94%, 99.95%, 99.96%, 99.97%, 99,98%, 99,99%, or more. The plurality of atoms may comprise lithium-6 atoms, lithium-7 atoms, sodium-23 atoms, potassium-39 atoms, potassium-40 atoms, potassium-41 atoms, rubidium-85 atoms, rubidium-87 atoms, caesium-133 atoms, beryllium-9 atoms, magnesium-24 atoms, magnesium-25 atoms, magnesium-26 atoms, calcium-40 atoms, calcium-42 atoms, calcium-43 atoms, calcium-44 atoms, calcium-46 atoms, calcium-48 atoms, strontium-84 atoms, strontium-86 atoms, strontium-87 atoms, strontium-88 atoms, barium-130 atoms, barium-132 atoms, barium-133 atoms, barium-134 atoms, barium-135 atoms, barium-136 atoms, barium-137 atoms, barium-138 atoms, scandium-45 atoms, yttrium-89 atoms, lanthanum-139 atoms, cerium-136 atoms, cerium-138 atoms, cerium-140 atoms, cerium-142 atoms, praseodymium-141 atoms, neodymium-142 atoms, neodymium-143 atoms, neodymium-145 atoms, neodymium-146 atoms, neodymium-148 atoms, samarium-144 atoms, samarium-149 atoms, samarium-150 atoms, samarium-152 atoms, samarium-154 atoms, europium-151 atoms, europium-153 atoms, gadolinium-154 atoms, gadolinium-155 atoms, gadolinium-156 atoms, gadolinium-157 atoms, gadolinium-158 atoms, gadolinium-160 atoms, terbium-159 atoms, dysprosium-156 atoms, dysprosium-158 atoms, dysprosium-160 atoms, dysprosium-161 atoms, dysprosium-162 atoms, dysprosium-163 atoms, dysprosium-164 atoms, erbium-162 atoms, erbium-164 atoms, erbium-166 atoms, erbium-167 atoms, erbium-168 atoms, erbium-170 atoms, holmium-165 atoms, thulium-169 atoms, ytterbium-168 atoms, ytterbium-170 atoms, ytterbium-171 atoms, ytterbium-172 atoms, ytterbium-173 atoms, ytterbium-174 atoms, ytterbium-176 atoms, lutetium-175 atoms, or lutetium-176 atoms enriched to an isotopic abundance of at most about 99.99%, 99.98%, 99.97%, 99.96%, 99.95%, 99.94%, 99.93%, 99.92%, 99.91%, 99.9%, 99.8%, 99.7%, 99,6%, 99.5%, 99.4%, 99.3%, 99.2%, 99.1%, 99%, 98%, 97%, 96%, 95%, 94%, 93%, 92%, 91%, 90%, 80%, 70%, 60%, 50%, or less. The plurality of atoms may comprise lithium-6 atoms, lithium-7 atoms, sodium-23 atoms, potassium-39 atoms, potassium-40 atoms, potassium-41 atoms, rubidium-85 atoms, rubidium-87 atoms, caesium-133 atoms, beryllium-9 atoms, magnesium-24 atoms, magnesium-25 atoms, magnesium-26 atoms, calcium-40 atoms, calcium-42 atoms, calcium-43 atoms, calcium-44 atoms, calcium-46 atoms, calcium-48 atoms, strontium-84 atoms, strontium-86 atoms, strontium-87 atoms, strontium-88 atoms, barium-130 atoms, barium-132 atoms, barium-133 atoms, barium-134 atoms, barium-135 atoms, barium-136 atoms, barium-137 atoms, barium-138 atoms, scandium-45 atoms, yttrium-89 atoms, lanthanum-139 atoms, cerium-136 atoms, cerium-138 atoms, cerium-140 atoms, cerium-142 atoms, praseodymium-141 atoms, neodymium-142 atoms, neodymium-143 atoms, neodymium-145 atoms, neodymium-146 atoms, neodymium-148 atoms, samarium-144 atoms, samarium-149 atoms, samarium-150 atoms, samarium-152 atoms, samarium-154 atoms, europium-151 atoms, europium-153 atoms, gadolinium-154 atoms, gadolinium-155 atoms, gadolinium-156 atoms, gadolinium-157 atoms, gadolinium-158 atoms, gadolinium-160 atoms, terbium-159 atoms, dysprosium-156 atoms, dysprosium-158 atoms, dysprosium-160 atoms, dysprosium-161 atoms, dysprosium-162 atoms, dysprosium-163 atoms, dysprosium-164 atoms, erbium-162 atoms, erbium-164 atoms, erbium-166 atoms, erbium-167 atoms, erbium-168 atoms, erbium-170 atoms, holmium-165 atoms, thulium-169 atoms, ytterbium-168 atoms, ytterbium-170 atoms, ytterbium-171 atoms, ytterbium-172 atoms, ytterbium-173 atoms, ytterbium-174 atoms, ytterbium-176 atoms, lutetium-175 atoms, or lutetium-176 atoms enriched to an isotopic abundance that is within a range defined by any two of the preceding values.

In some cases, the first plurality of qubits comprises neutral atoms. In some cases, the second plurality of qubits can include neutral atoms. For example, the one or more atoms of the array can include one or more qubits. The one or more atoms can be configured to be usable as one or more qubits. The one or more qubits may be configured to perform a non-classical computation. For example, the one or more qubits can be configured to perform a gate-based quantum computation. In another example, the one or more qubits may be configured to perform a quantum computation. The one or more atoms may comprise at least about 1, 2, 3, 4, 5, 10, 15, 20, 25, 30, 35, 40, 45, 50, 55, 60, 65, 70, 75, 80, 85, 90, 95, 100, 110, 120, 130, 140, 150, 160, 170, 180, 190, 200, 300, 400, 500, or more atoms. The one or more atoms may comprise at most about 500, 400, 300, 200, 190, 180, 170, 160, 150, 140, 130, 120, 110, 100, 95, 90, 85, 80, 75, 70, 65, 60, 55, 50, 45, 40, 35, 30, 25, 20, 15, 10, 5, 4, 3, 2, or fewer atoms. The one or more atoms may comprise a number of atoms as defined by any two of the proceeding values. For example, the one or more atoms may comprise from about 75 to about 150 atoms.

### Systems for Error Corrected Quantum Computing

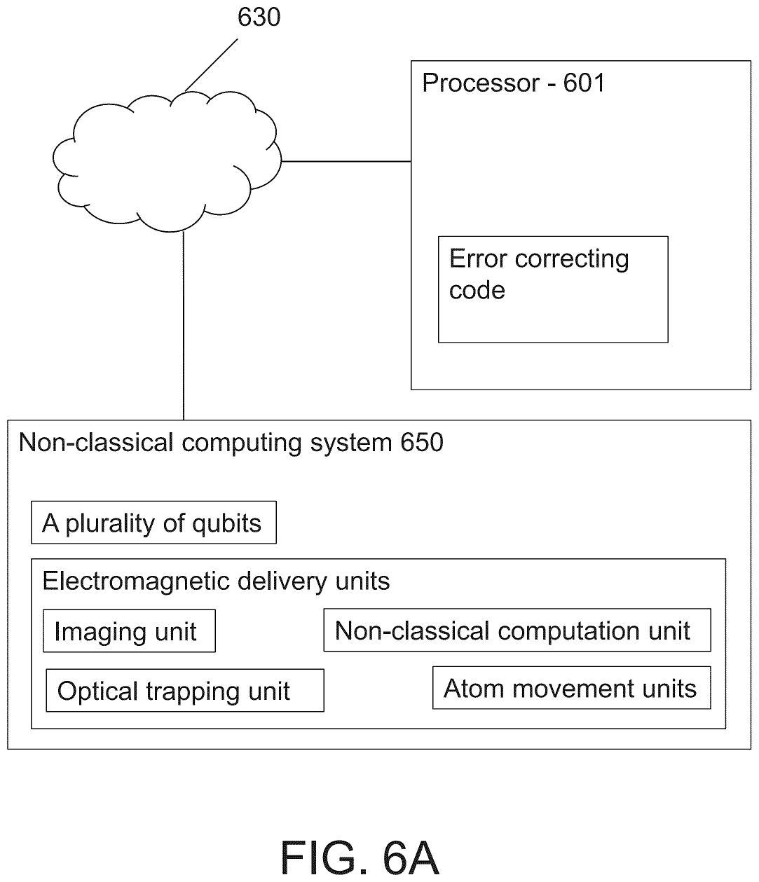

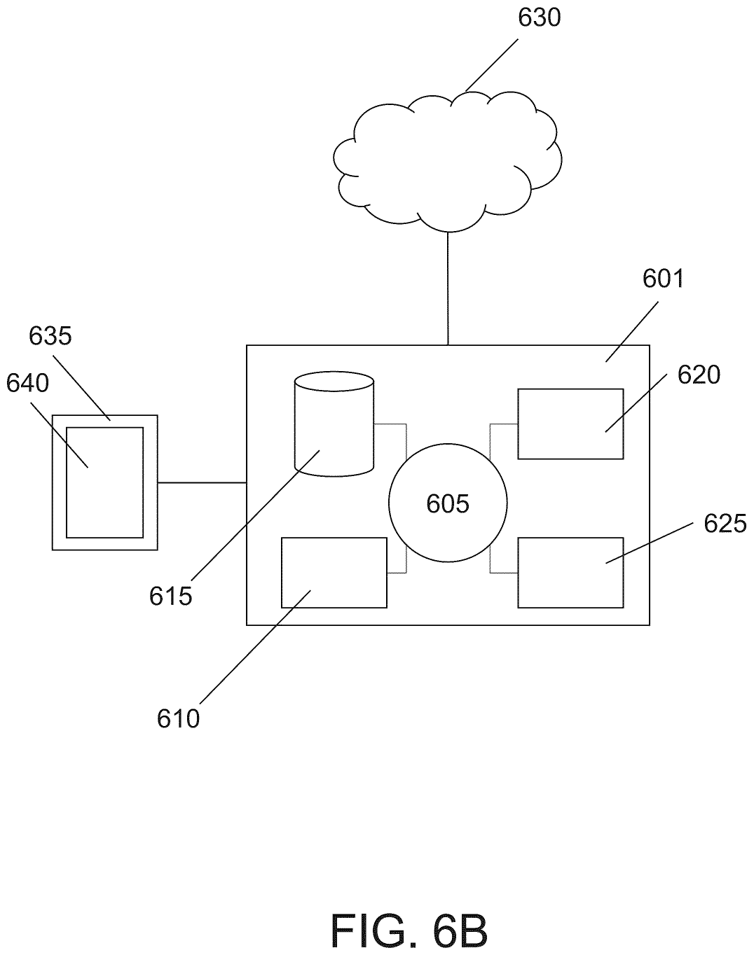

FIG. 6A shows a system for error corrected quantum computing that is programmed or otherwise configured to implement methods provided herein. A system for error corrected computing may comprise an error correcting code. The present disclosure provides systems for error corrected quantum computing. The system may comprise an error correction code. An implementation of the error correcting code may comprise a decoder. The decoder may be configured to receive a matching graph and to determine a set of edges, and the matching graph received by the decoder may be updated based on a predicted probability distribution of a lost qubit. In some cases, the error correction code comprises an operation in which a two-qubit interaction between a qubit and a lost qubit has an effect of a Pauli operation or an identity operation on the qubit. In some cases, the qubit is a non-lost qubit. In some cases, the qubit is a lost qubit.

In some cases, a system for error corrected quantum computing may comprise a non-classical computing system 650. The non-classical computing system may be quantum computing system. The non-classical computing system may be a trapped atom quantum computing system. The trapped atom quantum computing system may comprise: an atom movement unit, an atom rearrangement unit, an optical trapping unit, an imaging unit, an optical pumping unit, an entanglement unit, a Rydberg unit, a non-classical computation unit, an electromagnetic deliver unit, or any combination thereof.

In some cases, the non-classical computing system may comprise a plurality of qubits.

In some cases, the non-classical computing system may comprise one or more electromagnetic delivery units. The electromagnetic delivery units may be configured to produce electromagnetic excitations to perform various operations, such as for example, atom movement, atom rearrangement, optical trapping, imaging, and various operations on atoms that may comprises portions of a nonclassical computation. Portions of a non-classical computation on trapped atoms may comprise optical pumping, entanglement operations, Rydberg operations, gate operations (e.g., one qubit operations, two qubit operations, etc.). In some cases, an atom movement unit may comprise an atom rearrangement unit. The components of a non-classical computing system are discussed herein above with respect to the operations they implement.

In some cases, the system further comprises a non-classical computing system, wherein the non-classical computing system comprises trapped atom qubits. In some cases, the trapped atom qubits comprise neutral atom qubits. In some cases, the neutral atom qubits comprise a Group II element or a Group II-like element. In some cases, the Group II element or a Group II-like element comprises Ytterbium, Rubidium, Cesium, or Strontium. In some cases, the plurality of qubits comprises qubit states comprising nuclear spin states on the ¹S₀ manifold. In some cases, the two-qubit interaction comprises an excitation of a nuclear spin state of a neutral atom to a Rydberg state of the neutral atom.

In some cases, the system further comprises a non-classical computing system, wherein the non-classical computing system comprises a plurality of qubits, wherein the plurality of qubits comprises atomic qubits, and wherein an atom replacement operation is implemented using optical tweezers.

In some cases, the non-classical computing system may be configured to interact with a processor 601. The processor may be classical processing system. The processor may be digital processing system.

In some cases, the system further comprises a processor configured to implement an error correcting code. In some cases, the processor is further configured to provide instructions to a non-classical computing system, wherein the non-classical computing system is configured to implement the instructions to: (i) identify that a qubit has been lost; (ii) replace the qubit; and (iii) reimplement the qubit into the circuit. In some cases, the processor is further configured to (iv) flag measurements taken while the qubit was missing as untrustworthy. In some cases. (i) comprises using a plurality of swap gates. In some cases, a swap gate within the plurality of swap gates is implemented as a plurality of CNOT gates. In some cases, the processor is further configured to provide instructions to the non-classical computing system to measure alternating atoms in a lattice; perform the plurality of swap gates to transfer data stored on data qubits to ancilla qubits; and measure the swapped data qubits to identify one or more lost atoms.

In some cases, (i) comprises using a modified knock-knock protocol, wherein the modified knock-knock protocol comprises: providing a first atom to be probed using a second atom, wherein the second atom is an ancilla qubit; preparing the second atom in a |+>state; applying a modified control-Z gate between the first atom and the second atom based on a Rydberg interaction; and rotating the second qubit back to a computational basis and performing a measurement. In some cases, (iii) comprises (A) use of a decoder algorithm, wherein the decoder algorithm takes in a graph and determines a set of edges. In some cases, prior to (A) the processor is further configured to update a matching graph passed to the decoder algorithm based on a predicted probability distribution of a lost qubit replaced in (ii). In some cases, (iii) comprises use of a minimum-weight perfect matching decoder algorithm. In some cases, the processor is further configured to update a matching graph passed to the minimum-weight perfect matching decoder algorithm based on a predicted probability distribution of a lost qubit replaced in (ii). In some cases, the processor is further configured to: if an ancilla qubit is lost, update the matching graph so that a node involving the ancilla qubit is connected by edges corresponding to the predicted probability distribution; and if a data qubit is lost, update the matching graph by assigning the predicted probability distribution to each node involving the data qubit. In some cases, each node involving the ancilla qubit is updated.

In some cases, the error correcting code is configured to be implemented during a quantum computation circuit. In some cases, the error correcting code is configured to be implemented without measurement of each or a plurality of data qubits. In some cases, the error correcting code is configured to be implemented substantially without loss of coherence of each or a plurality of data qubits. In some cases, processor is further configured to flag measurements taken during a window of time that includes a time when the lost qubit was missing as untrustworthy.

In some cases, the decoder comprises union find, tensor network decoder, belief propagation with ordered statistics decoder, maximum likelihood decoder, or a look up table decoder. In some cases, the decoder comprises minimum weight perfect matching. In some cases, the decoder comprises sparse blossom or fusion blossom. In some cases, the error correcting code comprises a topological code. In some cases, the topological code is a stabilizer code. In some cases, the error correcting code is a surface code, a color code, a toric code, a shor style code, or a qLDPC code. In some cases, the color code is a Steane code. In some cases, the shor style code is a Bacon-shor code. In some cases, the qLDPC code is a hypergraph product code. In some cases, each node in the matching graph corresponds to a change-of-value of a particular stabilizer and wherein pairs of nodes are connected by edges corresponding to possible physical errors. In some cases, the edges are weighted based on the likelihood of a particular error occurring. In some cases, atom loss is treated as a gate error that occurs with a probability of 50%.

In some cases, the processor is further configured to provide instructions to the non-classical computing system to perform a measurement operation, wherein the measurement operation is state selective. In some cases, the measurement operation comprises applying electromagnetic energy to a qubit to be measured, wherein the electromagnetic energy is configured to selectively drive the qubit to be measured from an initial state to an excited state in a presence of an applied magnetic field, wherein a selectivity of a transition to the excited state is based at least in part on a strength of the applied magnetic field. In some cases, the processor is further configured to determine that the qubit to be measured was in the initial state based at least in part on the qubit returning to the initial state by emission of a photon in response to the electromagnetic energy.

### Digital Computer Systems

FIG. 6B shows a computer system that is programmed or otherwise configured to implement methods provided herein. The present disclosure provides computer systems that are programmed to implement methods of the disclosure. FIG. 6B shows a computer system 601 that is programmed or otherwise configured to methods of the present disclosure such method 100, 200, 300, 400, or 500. The computer system 601 can regulate various aspects of error corrected quantum computing systems of the present disclosure, such as, for example, providing control signals to implement one or more operations on a plurality of qubits. The computer system 601 can be an electronic device of a user or a computer system that is remotely located with respect to the quantum computing system. The electronic device can be a mobile electronic device.

The computer system 601 includes a central processing unit (CPU, also “processor” and “computer processor” herein) 605, which can be a single core or multi core processor, or a plurality of processors for parallel processing. The computer system 601 also includes memory or memory location 610 (e.g., random-access memory, read-only memory, flash memory), electronic storage unit 615 (e.g., hard disk), communication interface 620 (e.g., network adapter) for communicating with one or more other systems, and peripheral devices 625, such as cache, other memory, data storage and/or electronic display adapters. The memory 610, storage unit 615, interface 620 and peripheral devices 625 are in communication with the CPU 605 through a communication bus (solid lines), such as a motherboard. The storage unit 615 can be a data storage unit (or data repository) for storing data. The computer system 601 can be operatively coupled to a computer network (“network”) 630 with the aid of the communication interface 620. The network 630 can be the Internet, an internet and/or extranet, or an intranet and/or extranet that is in communication with the Internet. The network 630 in some cases is a telecommunication and/or data network. The network 630 can include one or more computer servers, which can enable distributed computing, such as cloud computing. The network 630, in some cases with the aid of the computer system 601, can implement a peer-to-peer network, which may enable devices coupled to the computer system 601 to behave as a client or a server.

The CPU 605 can execute a sequence of machine-readable instructions, which can be embodied in a program or software. The instructions may be stored in a memory location, such as the memory 610. The instructions can be directed to the CPU 605, which can subsequently program or otherwise configure the CPU 605 to implement methods of the present disclosure. Examples of operations performed by the CPU 605 can include fetch, decode, execute, and writeback.

The CPU 605 can be part of a circuit, such as an integrated circuit. One or more other components of the system 601 can be included in the circuit. In some cases, the circuit is an application specific integrated circuit (ASIC).

The storage unit 615 can store files, such as drivers, libraries and saved programs. The storage unit 615 can store user data, e.g., user preferences and user programs. The computer system 601 in some cases can include one or more additional data storage units that are external to the computer system 601, such as located on a remote server that is in communication with the computer system 601 through an intranet or the Internet.

The computer system 601 can communicate with one or more remote computer systems through the network 630. For instance, the computer system 601 can communicate with a remote computer system of a user. Examples of remote computer systems include personal computers (e.g., portable PC), slate or tablet PC's (e.g., Apple® iPad, Samsung® Galaxy Tab), telephones, Smart phones (e.g., Apple® iphone, Android-enabled device, Blackberry®), or personal digital assistants. The user can access the computer system 601 via the network 630.

For instance, the computer system 601 can communication with a non-classical computing system 650. In some cases, the non-classical computing system is local to processor 601. In some cases, the non-classical computing system is remote to processor 601. The processor may access processor 601 over a network 630.

Methods as described herein can be implemented by way of machine (e.g., computer processor) executable code stored on an electronic storage location of the computer system 601, such as, for example, on the memory 610 or electronic storage unit 615. The machine executable or machine-readable code can be provided in the form of software. During use, the code can be executed by the processor 605. In some cases, the code can be retrieved from the storage unit 615 and stored on the memory 610 for ready access by the processor 605. In some situations, the electronic storage unit 615 can be precluded, and machine-executable instructions are stored on memory 610.

The code can be pre-compiled and configured for use with a machine having a processer adapted to execute the code or can be compiled during runtime. The code can be supplied in a programming language that can be selected to enable the code to execute in a pre-compiled or as-compiled fashion.

Aspects of the systems and methods provided herein, such as the computer system 601, can be embodied in programming. Various aspects of the technology may be thought of as “products” or “articles of manufacture” typically in the form of machine (or processor) executable code and/or associated data that is carried on or embodied in a type of machine-readable medium. Machine-executable code can be stored on an electronic storage unit, such as memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical, and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

Hence, a machine-readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 601 can include or be in communication with an electronic display 635 that comprises a user interface (UI) 640. Examples of UI's include, without limitation, a graphical user interface (GUI) and web-based user interface.

Methods and systems of the present disclosure can be implemented by way of one or more algorithms. An algorithm can be implemented by way of software upon execution by the central processing unit 605. The algorithm can, for example, be a variation, example, or embodiment of an error correcting algorithm, a decoder, a quantum circuit, etc.

### EXAMPLES

The following example describes simulation results of a procedure for the surface code using a minimum-weight perfect matching decoder.

Methods—The circuit simulations were performed using Stim. We simulated surface code memory experiments consisting of d rounds of syndrome extraction for a distance d surface code. Typical distances were in the set {3, 5, 7, 9}. The simulation used standard depolarizing noise on single-and two-qubit gates, as well as readout error, state-preparation error, and per-round idle error. We also included loss. To simulate loss, we adopted the model that for each circuit step (round of parallel gates or operations) there was a uniform probability of loss for each atom. All noise channels, including loss, were set to have equal probabilities throughout the simulation.

To simulate atom loss, the loss events were randomly pre-generated on a per-shot basis. In Stim, any two-qubit gates involving a lost atom were replaced with identity gates. To simulate replacing an atom we performed qubit reset followed by a fully depolarizing noise channel on the replaced atoms. The decoding graph for the circuit was pre-computed assuming no lost atoms. On a per-shot basis, the decoding graph was updated based on atom loss events according the procedure in the preceding description. For surface code memory experiments described herein, all edges are graph-like (i.e., not hyperedges), simplifying the graph modification procedure. However, the method may be extended to hyperedges. Thus, each lost ancilla corresponded to a single 50% error edge between two detectors. Each data qubit participates in either two (boundary qubits) or four (bulk qubits) syndrome checks per round, so for each lost data qubit we added two or four 50% error edges between the corresponding detectors. The simulated data and the modified decoding graph were decoded using minimum-weight perfect matching, implemented by Pymatching.

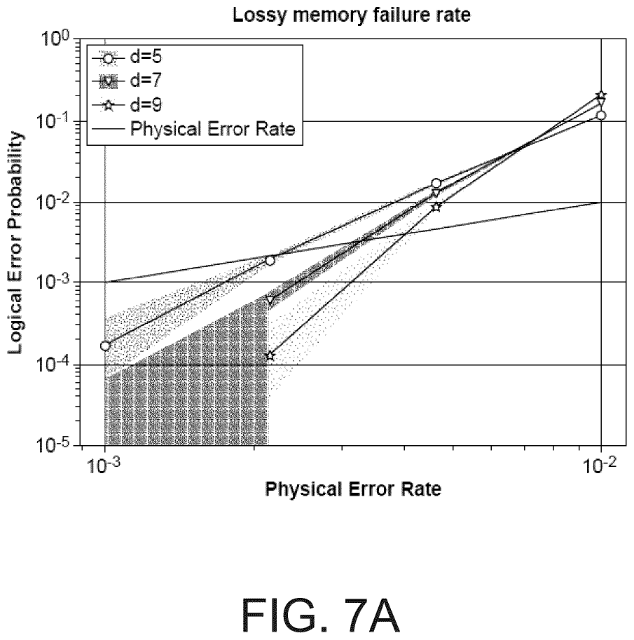

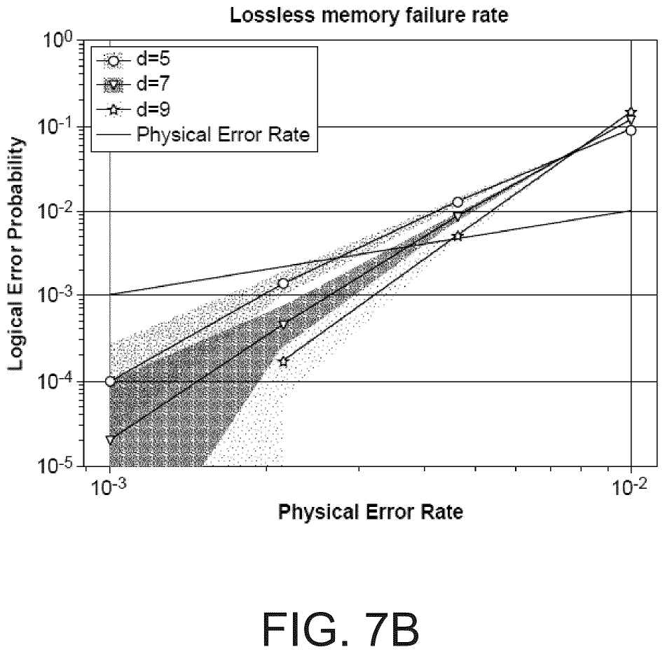

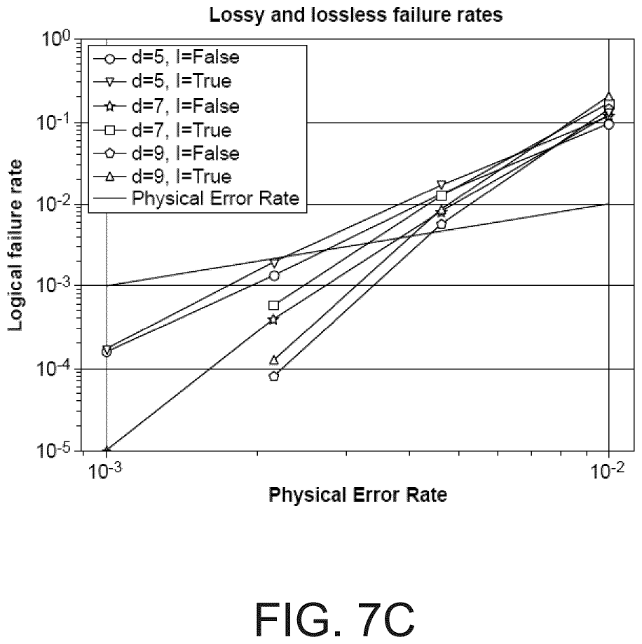

Results—FIGS. 7A, 7B, and 7C show simulation results from experimental implementations of the systems and methods disclosed herein. The simulations with performed with and without loss. FIG. 7A is a plot of simulation data showing a plot of physical error rate versus logical error probability for a model which considers atom loss. Sources of error considered include state preparation, state readout, single-qubit gate errors, two-qubit gate errors, qubit loss rate, and loss-correlated induced noise. FIG. 7B is a plot of simulation data showing a plot of physical error rate versus logical error probability for a model which does not consider atom loss. Sources of error considered include state preparation, state readout, single-qubit gate errors, and two-qubit gate errors.

FIG. 7C is an overlay of the data in FIG. 7A and FIG. 7B. The results comparing the lossy and lossless simulations are shown in FIG. 7C. Though loss does hurt thresholds, the results show that the effect is small. Furthermore, for each specific code size the results with loss scale asymptotically with the same exponent as the results without loss, showing that atom loss does not hurt the effective code distance.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations, or equivalents. It is intended that the following claims define the scope of the invention and that methods and structures within the scope of these claims and their equivalents be covered thereby.

1.-122. (canceled)

123. A method for error corrected quantum computation, the method comprising:
(a) identifying a lost qubit within an array of qubits;
(b) replacing said lost qubit with a replacement qubit;
(c) reimplementing said replacement qubit into a quantum circuit; and
(d) flagging measurements taken while said lost qubit was missing as untrustworthy.

124. The method of claim 123, wherein said identifying in (a) comprises using a plurality of swap gates.

125. The method of claim 124, wherein a swap gate within said plurality of swap gates is implemented as a plurality of CNOT gates.

126. The method of claim 124, further comprising:
measuring alternating qubits in a lattice;
performing said plurality of swap gates to transfer data stored on data qubits to ancilla qubits; and
measuring said data qubits to identify said lost qubit in (a).

127. The method of claim 123, wherein identifying in (a) comprises using a modified knock-knock protocol, wherein said modified knock-knock protocol comprises:
providing a first qubit to be probed using a second qubit, wherein said second qubit is an ancilla qubit;
preparing said second qubit in a |+>state;
applying a control-Z gate between said first qubit and said second qubit;
rotating said second qubit back to a computational basis; and
performing a measurement on said second qubit to identify said lost qubit in (a).

128. The method of claim 123, wherein said reimplementing in (c) comprises: (i) at a decoder algorithm, taking in a graph and determining a set of edges, a set of hyperedges, or both.

129. The method of claim 128, wherein, prior to (i), the method comprises updating a matching graph passed to said decoder algorithm based at least in part on a predicted probability distribution of a lost qubit replaced in (b).

130. The method of claim 129, wherein said decoder algorithm is a minimum-weight perfect matching decoder algorithm, union find, tensor network decoder, belief propagation with ordered statistics decoder, maximum likelihood decoder, or a look up table decoder.

131. The method of claim 130, wherein said decoder algorithm is a minimum-weight perfect matching decoder algorithm, and wherein the method further comprises: updating a matching graph passed to said minimum-weight perfect matching decoder algorithm based on a predicted probability distribution of said lost qubit.

132. The method of claim 131, further comprising:
if an ancilla qubit is lost, updating said matching graph so that a node involving said ancilla qubit is connected by edges corresponding to said predicted probability distribution of said lost qubit; and
if a data qubit is lost, updating said matching graph by assigning said predicted probability distribution to each node involving said data qubit.

133. The method of claim 123, further comprising performing (a)-(d) during a quantum computation circuit.

134. The method of claim 123, wherein (d) comprises flagging a measurement taken during a window of time that includes a time when said lost qubit was missing as untrustworthy.

135. The method of claim 123, wherein said lost qubit, said replacement qubit, or both is a trapped atom qubit.

136. The method of claim 135, wherein said trapped atom qubit is a neutral atom qubit, and wherein said trapped atom qubit comprises qubit states comprising nuclear spin states.

137. The method of claim 136, wherein said neutral atom qubit is a Group II element or a Group II-like element.

138. The method of claim 123, wherein said identifying in (a) comprises an operation in which a two-qubit interaction between a qubit and said lost qubit has an effect of a Pauli operation or an identity operation on said qubit.

139. The method of claim 138, wherein said two-qubit interaction comprises an excitation of a nuclear spin state of a neutral atom to a Rydberg state of said neutral atom.

140. The method of claim 123, wherein (a)-(d) comprise a portion of an error correcting code, and wherein said error correcting code comprises a topological code, a stabilizer code, a surface code, a color code, a toric code, a shor style code, or a qLDPC code.

141. The method of claim 123, wherein said reimplementing at (c) comprises: implementing an error correction code, wherein an implementation of said error correcting code comprises a decoder, wherein said decoder is configured to receive a matching graph and to determine a set of edges, and wherein said matching graph received by said decoder is updated based on a predicted probability distribution of said lost qubit.

142. The method of claim 141, wherein each node in said matching graph corresponds to a change-of-value of a particular stabilizer, and wherein pairs of nodes are connected by edges corresponding to possible physical errors.

143. The method of claim 142, wherein said edges are weighted based on a likelihood of a particular error occurring.
